(19) United States
(12) Patent Application Publication
(10) Pub. No.: US 2006/0201884 A1
(43) Pub. Date: Sep. 14, 2006

(54) High flux, microporous, sieving membranes and separators containing such membranes and processes using such membranes

(76) Inventors: Santi Kulprathipanja, Inverness, IL (US); Chunquing Liu, Schaumburg, IL (US); Stephen T. Wilson, Libertyville, IL (US); David A. Lesch, Hoffman Estates, IL (US); Lynn H. Rice, Arlington Heights, IL (US); David J. Shecterle, Arlington Heights, IL (US); Dale J. Shields, Grayslake, IL (US); Stanley J. Frey, Palatine, IL (US)

Correspondence Address: JOHN G TOLOMEI, PATENT DEPARTMENT;UOP LLC, 25 EAST ALGONQUIN ROAD, P O BOX 5017, DES PLAINES, IL, 60017-5017, US

(21) Appl. No.: 11/372,510

(22) Filed: Mar. 10, 2006

Related U.S. Application Data
(60) Provisional application No. 60/661,087, filed on Mar. 11, 2005.
(60) Provisional application No. 60/660,958, filed on Mar. 11, 2005.
(60) Provisional application No. 60/660,959, filed on Mar. 11, 2005.
(60) Provisional application No. 60/661,086, filed on Mar. 11, 2005.
(60) Provisional application No. 60/661,247, filed on Mar. 11, 2005.

(51) Int. Cl. B01D 61/00

(52) U.S. Cl. 210/651; 208/133; 210/500.27

(57) ABSTRACT

A sieving membrane comprises a thin, microporous barrier to provide a high flux. The membrane structure can tolerate defects yet still obtain commercially-attractive separations.

### CROSS-REFERENCE TO RELATED APPLICATIONS

This application claims priority from Provisional Application Ser. Nos. 60/661,087, 60/660,958, 60/660,959, 60/661,086, and 60/661,247 all filed Mar. 11, 2005, the contents of which are all hereby incorporated by reference.

### FIELD OF THE INVENTION

This invention pertains to high flux membranes using microporous barriers to effect rates of passage of molecules therethrough and separators containing such membranes and processes for using such membranes.

### BACKGROUND OF THE INVENTION

Membranes have long been proposed as a tool for separating components from gases and liquids. The membranes may be of various types using various transport mechanisms. Several examples to give the breadth of different types of membranes include:
supported liquid membranes in which a component in a fluid mixture complexes with a complexing agent retained within the membrane and is transported to the opposite side of the membrane, wherein the driving force for such a separation is the partial pressure differential or concentration differential for the component to be separated across the membrane;
polymeric and metallic (such as platinum or palladium) membranes, especially those with a relatively pore-free barrier layer into which the component of a gas or liquid is dissolved and is transported to the opposite side of the membrane, wherein the driving force for such a separation is a partial pressure differential or concentration differential; and
diffusivity membranes in which separation is effected by differentials in Knudsen diffusion.

Depending upon the complexing agent or the polymer and the nature of the components in the fluid that is subjected to separation, a high degree of separation can be achieved with supported liquid membranes and polymeric and metallic membranes.

Supported liquid membranes and polymeric membranes, due to the mode of transport, are often limited in the types of separation that can be effected. This is particularly true when a component is sought to be separated from a mixture containing components of similar chemical characteristics, e.g., similar solubilities in polymers or similar rates of complexing with complexing agents.

Efforts have been undertaken to develop membranes that effect separation based upon the physical sizes of the components in the mixture from which a component is sought to be removed. These membranes usually use a microporous structure that is size selective. Porous metal, ceramic, carbon and glass structures have been proposed as well as composite structures containing shape-selective materials.

Also, proposals have been make for membranes that use selective sorption using molecular sieves. For instance, proposals have included mixed polymer and molecular sieve membranes (mixed matrix membranes). See, for instance, U.S. Pat. No. 4,740,219 and U.S. Pat. No. 5,127,925. U.S. Pat. No. 5,069,794 discloses microporous membranes containing crystalline molecular sieve material. At column 8, lines 11 et seq., potential applications of the membranes are disclosed including the separation of linear and branched paraffins. See also, U.S. Pat. No. 6,090,289, disclosing a layered composite containing molecular sieve that could be used as a membrane. Among the potential separations in which the membrane may be used that are disclosed commencing at column 13, line 6, include the separation of normal paraffins from branched paraffins. U.S. Pat. No. 6,156,950 and U.S. Pat. No. 6,338,791 discuss permeation separation techniques that may have application for the separation of normal paraffins from branched paraffins and describe certain separation schemes in connection with isomerization. US 2003/0196931 discloses a two-stage isomerization process for up-grading hydrocarbon feeds of 4 to 12 carbon atoms. The use of zeolite membranes is suggested as a suitable technique for separating linear molecules. See, for instance, paragraphs 0008 and 0032. See also US 2005/0283037.

Bourney, et al., in WO 2005/049766 disclose a process for producing high octane gasoline using a membrane to remove, inter alia, n-pentane from an isomerized stream. In a computer simulation based upon the use of an MFI on alumina membrane, example 1 of the publication indicates that 5000 square meters of membrane surface area is required to remove about 95 mass percent of n-pentane from the overhead from a deisohexanizer distillation column. At the flow rate of feed to the permeator (75000 kg/hr. having 20.6 mass percent n-pentane), the flux of n-pentane used in the simulation appears to be in the order of 0.01 gram moles/m²·s at about 300° C.

U.S. Pat. No. 6,818,333 discloses thin zeolite membranes that are said to have a permeability of n-butane of at least 6·10⁻⁷ gram mol/m²·s·Pa and a selectivity of at least 250 of n-butane to isobutane. In general, these molecular sieve-containing membranes take advantage of the selective sorptive properties of the molecular sieves and the driving force for permeation continues to be partial pressure or concentration differentials. The patentees state that the zeolite layer is less than about 2 microns and recite that preferred membranes are those in which the zeolite layer is less than 0.5 micron. The examples in this patent describe the permeances of several membranes between 7.10 and 20.95×10⁻⁷ gram moles of n-butane/m²·s·Pa at 180° C. The permeances were determined at a pressure of 15 MPa on the feed side and atmospheric pressure on the permeate side of the membrane. The membranes exhibited high selectivity in the separation of n-butane from an n-butane and i-butane-containing mixture. With only a 0.05 MPa pressure differential, a commercial operation would require substantial membrane surface area.

Caro, et al., in “Zeolite membranes—state of their development and perspective”, Microporous and Mesoporous Materials 38 (2000) pp 3-24, note at page 16 various observations that have been made for the permeation of n-/i-butane and of n-hexane and 2,2-dimethylbutane on an MFI membrane. They relate that the flux and separation factor are affected by the feed partial pressures and thus pore fillings. See FIG. 10 at page 16. Interestingly, while the n-butane flux increases with increasing feed partial pressure over the range of 0 to 0.5 atmospheres partial pressure, the increase in flux is not in step with the increase in partial pressure. Consequently, a permeance determined at, say, a partial pressure of 0.1 atmosphere partial pressure would be significantly greater than that determined at 0.5 atmosphere. Based upon the disclosure of Caro, et al., one is led to believe that limits exist on the ability to reduce total membrane surface area required for a commercial-scale separation by increasing the partial pressure differential driving force.

The thrust has been toward making membranes that exhibit high selectivity either through the solubility, complexing or sorptive properties of the medium effecting the separation in the membrane structure. Thus, the segment of the membrane providing the selectivity needs to have excellent integrity. To prevent defects that permit undesired components to pass through the membrane, the approaches have been to provide the separating medium with sufficient thickness that frequency of defects is extremely small. Unfortunately, this approach results in membranes that exhibit lower flux rates such as disclosed in U.S. Pat. No. 6,818,333. Consider also, ZSM-5/Silicalite (MFI) membranes (a sieving membrane) available from NGK Insulators, Ltd., Japan, that have selectivity for the permeation of normal paraffins over branched paraffins, have a flux under operating conditions in the range of about 0.1 to 1.0 milligram moles per second per square meter at a pressure differential of about 15 to 500 kPa. Thus, particularly for high volume fluid flows such as would be the case in refineries and commodity chemical processes, the costs for commercially implementing such a membrane separation system render it not competitive with respect to alternative separation processes such as an adsorption separation system or even distillation.

Another approach to make membranes has been to embed molecular sieve in a polymer matrix. See, for instance, U.S. Pat. No. 4,735,193; U.S. Pat. No. 4,925,459; U.S. Pat. No. 4,925,562; U.S. Pat. No. 6,248,682; and U.S. Pat. No. 6,503,295. The polymer matrix is additive to the resistance to permeation through the membrane.

U.S. Pat. No. 5,968,366 proposed using a selectivity enhancing coating to enhance the performance of a molecular sieve-containing membrane structure. The patentees state that the coatings may stabilize, e.g., prevent the formation of defects and voids in the molecular sieve layer, as well as seal defects. The patentees caution that the coatings must interact with the zeolite without blocking or impeding molecular transport through pore openings of the zeolite layer. (Column 11, lines 11 to 13.) They further state that:
“For the composition to have an adequate flux, the selectivity enhancing coating should increase the mass transfer resistance the compositions offers to molecules permeating through the zeolite layer by no more than a factor of five.” (Column 11, lines 60 to 63.)

Although numerous approaches have been taken to provide selectively permeable membranes, heretofore practical considerations such as barrier layer integrity and strength have limited the permeance achievable thereby rendering the membranes economically unattractive for many commercial applications. Accordingly, a new type of membrane is sought that provides a combination of permeance and selectivity that is economically viable, both in terms of capital (required surface area of membrane) and operating costs, in comparison to other separation unit operations such as distillation, crystallization, liquefaction, and selective sorption.

The following defined terms are used for the purposes of the discussion of the invention.

Microporous

Microporous and microporosity refer to pores having effective diameters of between about 0.3 to 2 nanometers.

Mesoporous

Mesoporous and mesoporosity refer to pores having effective diameters of between 2 and 50 nanometers.

Macroporous

Macroporous and macroporosity refer to pores having effective diameters of greater than 50 nanometers.

Nanoparticle

Nanoparticles are particles having a major dimension up to about 100 nanometers.

Molecular Sieves

Molecular sieves are materials having microporosity and may be amorphous, partially amorphous or crystalline and may be zeolitic, polymeric, metal, ceramic or carbon.

Sieving Membrane

Sieving membrane is a composite membrane containing a continuous or discontinuous selective separation medium containing molecular sieve barrier. A barrier is the structure that exists to selectively block fluid flow in the membrane. In a continuous sieving membrane, the molecular sieve itself forms a continuous layer that is sought to be defect-free. The continuous barrier may contain other materials such as would be the case with mixed matrix membranes. A discontinuous sieving membrane is a discontinuous assembly of molecular sieve barrier in which spaces, or voids, exist between particles or regions of molecular sieve. These spaces or voids may contain or be filled with other solid material. The particles or regions of molecular sieve are the barrier. The separation effected by sieving membranes may be on steric properties of the components to be separated. Other factors may also affect permeation. One is the sorptivity or lack thereof by a component and the material of the molecular sieve. Another is the interaction of components to be separated in the microporous structure of the molecular sieve. For instance, for some zeolitic molecular sieves, the presence of a molecule, say, n-hexane, in a pore, may hinder 2-methylpentane from entering that pore more than another n-hexane molecule. Hence, zeolites that would not appear to offer much selectivity for the separation of normal and branched paraffins solely from the standpoint of molecular size, may in practice provide greater selectivities of separation.

Steric Separation Pair

A Steric Separation Pair is two molecules that are sought to be separated by a sieving membrane and have different molecular sizes such as n-butane (0.43 nm) and i-butane (0.50 nm) selected such that the smaller molecule (Permeant) will fit into the micropore of the molecular sieve whereas the larger (Retentant) will not so readily enter the micropore. The Steric Separation Pair may have the same or similar molecular weight or may be of substantially different molecular weight. For different Steric Separation Pairs, different molecular sieves may be required to effect the separation. For instance, molecular sieves having larger openings may be suitable for the separation of alkylbenzene from phenylalkylbenzene. Molecular sieves with smaller openings would be preferred for the separation of methane from ethane or ethane from ethylene. A steric pair may be in a bicomponent fluid feed or a multicomponent fluid feed to a sieving membrane. Where multicomponent, the fluids feed may contain other components of smaller, larger or intermediate molecular sizes. The Retentant and the Permeant selected for the Steric Separation Pair in such a multicomponent feed will be the primary component sought for the retentate side of the membrane and the primary component sought to be permeated to the permeate side of the membrane. Thus, if the sought separation were n-butane from i-butane, and the fluid feed contained methane and n-pentane, the Steric Separation Pair would be n-butane (Permeant) and i-butane (Retentant).

Permeant Flow Index

The permeability of a sieving membrane, i.e., the rate that a given component passes through a given thickness of the membrane, often varies with changes in conditions such as temperature and pressure, absolute and differential. Thus, for instance, a different permeation rate may be determined where the absolute pressure on the permeate side is 1000 kPa rather than where that pressure is 5000 kPa, all other parameters, including pressure differential, being constant. Accordingly, a Permeate Flow Index is used herein for describing sieving membranes. The Permeate Flow Index for a given membrane is determined by measuring the rate (gram moles per square meter of membrane surface area per second) at which a substantially pure Permeant (preferably at least about 95 weight percent Permeant) permeates the membrane at approximately 150° C. at a retentate side pressure of about 200 kPa absolute and a permeate-side pressure of about 100 kPa absolute. The Permeate Flow Index reflects the permeation rate per square meter of retentate-side surface area but is not normalized to membrane thickness.

Permeant Flow Ratio

The Permeant Flow Ratio for a given sieve membrane is the ratio of the Permeant Flow Index to a similarly determined flow index for the Retentant (the Retentant Flow Index).

Intrinsic Permeation Thickness

The intrinsic permeation thickness of a sieving membrane is the theoretical thickness of a continuous, defect-free, molecular sieve barrier that would provide the same Permeant Flow Index as observed with the sieving membrane. The intrinsic permeation thickness is determined by making a membrane in which the molecular sieve forms a continuous barrier layer of about 500 to 750 nm in thickness (Reference Membrane). The Permeant Flow Index is determined for the Reference Membrane for the Permeant as set forth above, and the intrinsic permeation thickness (ITC) is calculated as follows:

$$ITC ( nm ) = \frac{( Permeant Flow Index of the sieving membrane )}{\begin{matrix}( Permeant Flow Index of the \\ Reference Membrane \times ( {t}_{obs} / 500 ) )\end{matrix}}$$

where t_{obs} is the observed thickness of the molecular sieve layer in the reference membrane. The intrinsic permeation thickness for a given sieving membrane can vary upon what Permeant is used as well as the actual thickness of the continuous barrier of the Reference Membrane as often flux through a molecular sieve barrier is not in a linear relationship to thickness. Nevertheless, the intrinsic permeation thickness together with the Permeant Flow Ratio provides some basis for a general understanding of the performance of a sieving membrane over a wide range of Permeants and Retentants.

For petroleum refining processes involving naphtha range boiling fractions, a representative Steric Separation Pair is n-hexane and dimethylbutane. For this Steric Separation Pair, the following definitions will be used.

C₆ Permeate Flow Index

A C₆ Permeate Flow Index for a given membrane is determined by measuring the rate (gram moles per second) at which a substantially pure normal hexane (preferably at least about 95 weight percent normal hexane) permeates the membrane at approximately 150° C. at a retentate side pressure of about 1000 kPa absolute and a permeate-side pressure of about 100 kPa absolute which are more representative of pressure differentials for refining process applications. The C₆ Permeate Flow Index reflects the permeation rate per square meter of retentate-side surface area but is not normalized to membrane thickness.

C₆ Permeate Flow Ratio

The C₆ Permeate Flow Ratio for a given sieve membrane is the ratio of the C₆ Permeate Flow Index to an i-C₆ Permeate Flow Index wherein the i-C₆ Permeate Flow Index is determined in the same manner as the C₆ Permeate Flow Index but using substantially pure dimethylbutanes (regardless of distribution between 2,2-dimethylbutane and 2,3-dimethylbutane) (preferably at least about 95 weight dimethylbutanes).

Low Selectivity Membrane

A Low Selectivity Membrane is one which for a Steric Separation Pair exhibits a Permeate Flow Ratio of between about 1.1:1 and 8:1.

### SUMMARY OF THE INVENTION

In accordance with this invention, sieving membranes are provided that are capable of high flux. Preferably, the sieving membranes of this invention have an Intrinsic Permeation Thickness of less than about 100, and sometimes less than about 70, even less than about 50, nanometers for at least one Permeant, yet can achieve some separation for a Steric Separation Pair. Often the Intrinsic Permeation Thickness is at least about 2, and sometimes at least about 5, nanometers.

In one broad aspect of the invention the sieving membranes comprise a discontinuous assembly of microporous barrier, said barrier having a major dimension less than about 100 nanometers, associated with a meso/macroporous structure defining fluid flow pores, wherein barrier is positioned to hinder fluid flow through the pores of the meso/macroporous structure. A molecular sieve barrier is “associated” with a meso/macroporous structure when it is positioned on or in the structure whether or not bonded to the structure. In accordance with this aspect of the invention, the sieving membranes exhibit high flux for the Permeant of a Steric Separation Pair. By constructing the membrane as a discontinuous barrier, the need for substantial thicknesses of barrier layers that have heretofore been proposed to ensure mechanical strength and avoid breaches, is obviated. Hence, nano-sized particles or islands of molecular sieve are used as barriers for the membranes of this aspect of the invention.

Without wishing to be limited to theory, the use of nano-sized particles or islands of sieving material facilitate achieving high flux not only because of the small size but also because a traditional membrane barrier film or continuous layer is not extant. Moreover, it is not necessary that a Permeant pass through the entire thickness of the barrier layer. Rather, the Permeant need only pass in and out of channels in the microporous barrier which can be only a fraction of the major dimension of the particle or island. Accordingly high Permeant Flow Indices can be achieved. The advantages of such high Permeant Flow Indices are observable in one or both of reduced membrane surface area and lower driving forces for Permeant recovery as compared to traditional membranes as discussed above.

An additional advantage over traditional membrane films is that the discontinuous sieving membranes of this invention are not subject to the same thermal expansion constraints. With membrane films such as zeolitic films, differences in thermal expansion between the film and support lead to degradation of the film. To avoid these problems, the supports have been selected to have similar coefficients of thermal expansion. Even then, film thicknesses have to be sufficient to withstand differences in the rates of expansion and contraction as well as any even very small mismatch in the coefficients. With the molecular sieve having a major dimension of up to about 100 nanometers, not only is any thermal expansion or contraction relatively de minimis, but also, the forces required to break the small molecular sieve particle are not likely to be generated even with substantial differentials in coefficients of expansion between the material of the molecular sieve and that of the meso/macroporous structure.

In this broad aspect of the invention, the discontinuous, microporous barrier is positioned to hinder fluid flow through fluid flow channels defined by the meso/macroporous structure. The barrier may be at least partially occluding the opening of a fluid flow channel of the meso/macroporous structure and/or within the fluid flow channel. Due to the small size of the particles or islands forming the discontinuous assembly of microporous barrier, some selectivity of separation is achievable despite the discontinuity. For a Steric Separation Pair for which separation can be effected by the micropores in the material of the barrier, the Permeant Flow Ratio is preferably at least about 1.1:1, more preferably at least about 1.25:1, and sometimes between about 1.35:1 and 8:1. Advantageously, the membranes of this invention can achieve even higher Permeant Flow Ratios by at least partially occluding at least a portion of the voids between molecular sieve barrier and between molecular sieve barrier and the material of the meso/macroporous structure with which the molecular sieve barrier is associated.

In another broad aspect of the invention pertaining to separations of hydrocarbon-containing components of 3 to 10 carbon atoms, the membranes comprise a microporous barrier in a meso/macroporous structure and are characterized as having a C₆ Permeate Flow Index of at least about 0.01, preferably at least about 0.02, and a C₆ Permeate Flow Ratio of at least about 1.1:1, preferably at least about 1.25:1, and sometimes between about 1.35:1 and 8:1. The preferred membranes of this invention are composite membranes comprising a macroporous support having non-selective fluid flow channels therethrough and in fluid flow restriction thereto, solid material disposed to define a microporous barrier. Without being limited to theory, the solid material (barrier material) may take any suitable form to provide the microporous barrier. For instance, the barrier material may be a coating that narrows a portion of a macropore to provide the sought microporous barrier. Alternatively, the barrier material may be a solid that contains a microporous structure. The barrier material may be positioned within a macropore or it may be a thin layer on a surface of or within the macroporous support. In the preferred membranes of this invention, the microporous barrier defines micropores having an average diameter of at least about 4.5 Å, preferably between about 5.0 and 10 or 20 Å, say, 5.2 to 6.0 Å. Micropores of 10 Å and less are referred to herein as subnanopores.

In accordance with this broad aspect of the invention, the microporous barrier is very thin such that a significant portion of the fluid permeating the membrane will pass through the microporous barrier rather than essentially all the fluid being diverted to pass through voids or defects. Consequently, a substantial number of voids or defects, especially those having relatively small effective diameters, can be tolerated in the membranes of this invention yet the membranes will still be suitable for many commercial applications. By small effective diameters it is meant that the combination of defect length and width in combination with its tortuosity through the thickness of the barrier layer, provides resistance to the flow of substantially pure cyclohexane equivalent to or less than a pore having an effective diameter of 6 Å, e.g., at an absolute pressure drop of 100 kPa across the membrane, the flux rate of normal hexane (at least 95 mass percent purity) is at least 1.2 times that of cyclohexane (at least 99 mass percent purity). Often the microporous barrier, i.e., the dimension of the barrier in the direction of permeation, “thickness”, is less than about 100, preferably less than about 75, say, about 20 to 60, nanometers. The microporous barrier may be continuous or discontinuous. Where the membrane is a composite, the macroporous support and barrier material together provide a continuous structure even though the barrier layer is discontinuous.

The separators of this invention are commercial-scale units containing membranes in accordance with this invention. A “commercial-scale” unit has the ability to process at least about 1000 kilograms of fluid per hour. 100381 The separators of this invention are particularly attractive for treating large volume process streams such as found in refineries and large scale chemical plants, especially where beneficial process improvements can be obtained even with relatively low separation such as in recovering normal paraffins from an isomerization reactor effluent for recycle to the reactor, in separating normal paraffins from branched and cyclic paraffins and aromatics to provide an enhanced feed to a steam cracker, and in separating alkylbenzenes from linear and lightly branched aliphatics and from benzene.

In its broad aspect, the processes of this invention separate by selective permeation at least one component from at least one other component in a fluid mixture containing said components by contact of said fluid with a feed side of a sieving membrane having an opposing permeate side under permeation conditions to provide on said feed side a retentate containing a reduced concentration of said at least one component and a permeate containing an enriched concentration of said at least one component on said permeate side, characterized in that said sieving membrane comprises at least one of:
a. a microporous barrier in a meso/macroporous structure, said membrane characterized in having a C₆ Permeate Flow Index of at least about 0.01 and a C₆ Permeate Flow Ratio of at least about 1.1:1, and
b. a discontinuous assembly of microporous barrier, said barrier having a major dimension less than about 100 nanometers associated with a meso/macroporous structure defining fluid flow pores, wherein barrier is positioned to hinder fluid flow through the pores of the meso/macroporous structure.

### BRIEF DESCRIPTION OF THE DRAWINGS

FIG. 1 is a conceptual representation of a segment of a sieving membrane in accordance with this invention wherein a coating on a portion of a meso/macropore structure of a support.

FIGS. 2 and 4 are conceptual representations of a segment of a sieving membrane in accordance with this invention wherein a molecular sieve occludes a portion of the meso/macropore structure of a support.

FIG. 3 is a conceptual representation of a segment of a sieving membrane in accordance with this invention wherein a thin molecular sieve layer resides on a surface of a meso/macroporous support.

FIG. 5 is a conceptual representation of a segment of a sieving membrane in accordance with this invention wherein nano-sized particles of molecular sieve are in the interstices of a meso/macroporous coating on a porous support.

FIG. 6 is a conceptual representation of a segment of a sieving membrane wherein nano-sized particles of molecular sieve are joined by a mortar material.

FIG. 7 is a conceptual representation of a segment of a sieving membrane wherein nano-sized particles of molecular sieve having the spaces or voids therebetween occluded with oligomer.

FIG. 8 is a schematic representation of a segment of a sieving membrane wherein nano-sized particles on which molecular sieve is grown to provide at least a partial coating and to provide interconnections with adjacent particles.

### DETAILED DESCRIPTION OF THE INVENTION

The high flux membranes of this invention can be obtained using a wide variety of techniques and may have different constructions. One type of sieving membrane in accordance with this invention has a discontinuous microporous barrier. In other aspects of this invention, the key feature of the membrane is high flux, even at low selectivities, regardless of whether or not the barrier is discontinuous or continuous. In either, a microporous barrier is used.

The microporous barrier may be formed by reducing the pore size of an ultrafiltration membrane (effective pore diameters of 1 to 100 nanometers) or a microfiltration membrane (effective pore diameters of 100 to 10,000 nanometers) by, e.g., organic or inorganic coating of the channel either interior of the surface, or preferably, at least partially proximate to the opening of the channel. These types of sieving membranes will be discussed in further detail in another portion of this description.

Other techniques for forming sieving membranes use a sieving material that is associated with a macroporous support. The sieving material, that is, the microporous barrier, may be of any suitable composition given the Steric Separation Pair to be separated and the conditions under which the separation is to be effected.

The molecular sieves can be zeolitic, polymeric, metal, ceramic or carbon, having microporosity. Zeolitic molecular sieves may be of any suitable combination of elements to provide the sought pore structure. Aluminum, silicon, boron, gallium, tin, titanium, germanium, phosphorus and oxygen have been used as building blocks for molecular sieves such as silica-alumina molecular sieves, including zeolites; silicalite; AIPO; SAPO; and boro-silicates. The precursor includes the aforementioned elements, usually as oxides or phosphates, together with water and an organic structuring agent which is normally a polar organic compound such as tetrapropyl ammonium hydroxide. Other adjuvants may also be used such as amines, ethers and alcohols. The mass ratio of the polar organic compound to the building block materials is generally in the range of about 0.1 to 0.5 and will depend upon the specific building blocks used. In order to prepare thin layers of molecular sieves in the membranes, it is generally preferred that the precursor solution be water rich. For instance, for silica-alumina molecular sieves, the mole ratio of water to silica should be at least about 20:1 and for aluminophosphate molecular sieves, the mole ratio should be at least about 20 moles of water per mole of aluminum.

The crystallization conditions for zeolites are often in the range of about 80° C. to 250° C. at pressures in the range of 100 to 1000, frequently 200 to 500, kPa absolute. The time for the crystallization is limited so as not to form an unduly thick layer of molecular sieve. In general, the crystallization time is less than about 50, say, 10 to 40, hours. Preferably the time is sufficient to form crystals but less than that required to form a molecular sieve layer of about 200 nanometers, say, about 5 to 50 nanometers. The crystallization may be done in an autoclave. In some instances, microwave heating will effect crystallization in a shorter period of time. The membrane is then washed with water and then calcined at about 350° to 550° to remove any organics.

Examples of zeolitic molecular sieves include small pore molecular sieves such as SAPO-34, DDR, AIPO-14, AIPO-17, AIPO-18, AIPO-34, SSZ-62, SSZ-13, zeolite 3A, zeolite 4A, zeolite 5A, zeolite KFI, H-ZK-5, LTA, UZM-9, UZM-13, ERS-12, CDS-1, Phillipsite, MCM-65, and MCM-47; medium pore molecular sieves such as silicalite, SAPO-31, MFI, BEA, and MEL; large pore molecular sieves such as FAU, OFF, NaX, NaY, CaY, 13X, and zeolite L; and mesoporous molecular sieves such as MCM-41 and SBA-15. A number of types of molecular sieves are available in colloidal (nano-sized particle) form such as A, X, L, OFF, MFI, and SAPO-34. The zeolites may or may not be metal exchanged. With smaller pore zeolites, the exchange metal can, in some instances, affect the size of the micropore. With larger pore zeolites, exchange may assist in effecting the separation. For instance, a silver exchanged molecular sieve may enhance the separation of olefins over alkanes. Where metal functionality is sought, it may, in certain instances, be provided by incorporating the metal in the framework, such as with gallium-containing molecular sieves. Framework metal may have an effect of the performance of the zeolite. For example, AIPO molecular sieves tend to have an affinity towards polar molecules. The zeolites may also be subjected to chemical or steam calcining to alter micropore size such as steam treating a Y-type zeolite to make ultra-stable Y having a larger pore structure.

Where zeolitic molecular sieves are used, obtaining small particles is important to obtaining the high flux in a discontinuous microporous barrier. For many zeolites, seed particles are available that are less than 100 nanometers in major dimension. Most molecular sieves are made using organic templates that must be removed to provide access to the cages. Typically this removal is done by calcination. As discussed later, the calcination may be effected when the template-containing molecular sieves are positioned in a macropore such that undue agglomeration is avoided simply by limiting the number of particles that are proximate. Another technique for avoiding agglomeration of the zeolite particles during calcination is to silate the surface of the zeolite, e.g., with an aminoalkyltrialkoxysilane, aminoalkylalkyldialkoxysilane, or aminoalkyldialkylalkoxysilane. The amount of silation required will depend upon the size of the zeolite and its composition as well as the conditions to be used for calcination. In general, between about 0.1 to 10 millimoles of silane are used per gram of zeolite.

Without being limited to theory, one preferred class of membranes for hydrocarbon separations where the intended Steric Separation Pair has between 3 and 10 carbons are those in which the sieving pores are sufficiently large that branched hexanes can pass through the pores but meet with more resistance than normal hexane. Often the pores for these types of membranes have an average pore diameter of greater than about 5.0 Å (average of length and width), say, about 5.0 to 7.0 Å. Preferably, the structures have an aspect ratio (length to width) of less than about 1.25:1, e.g., 1.2:1 to 1:1. For molecular sieve-containing membranes, exemplary structures are USY, ZSM-12, SSZ-35, SSZ-44, VPI-8, and Cancrinite.

Another class of preferred membranes is those with higher selectivity to the separation of normal hexane from branched hexanes where the sieving structure hinders branched hexanes from passing through a properly formed pore structure. In general, the pores for these types of membranes have an average micropore diameter of up to about 5.5 Å, for instance, about 4.5 to 5.4 Å. The aspect ratio of the micropores of these membranes may vary widely, and is usually in the range of about 1.5:1 to 1:1. For molecular sieve-containing membranes, exemplary structures are ZSM-5, silicalite, ALPO-11, ALPO-31, ferrierite, ZSM-11, ZSM-57, ZSM-23, MCM-22, NU-87, UZM-9, and CaA.

Other types of sieving materials include carbon sieves; polymers such as PIMs (polymers of intrinsic microporosity) such as disclosed by McKeown, et al., Chem. Commun., 2780 (2002); McKeown, et al., Chem. Eur. J., 11:2610 (2005); Budd, et al., J. Mater. Chem., 13:2721 (2003); Budd, et al., Adv. Mater., 16:456 (2004) and Budd, et al., Chem Commun., 230 (2004); polymers in which porosity is induced by pore-forming agents such as poly(alkylene oxide), polyvinylpyrrolidone; cyclic organic hosts such as cyclodextrins, calixarenes, crown ethers, and spherands; microporous metal-organic frameworks such as MOF-5 (or IRMOF-1); glass, ceramic and metal shapes into which microporosity has been introduced.

Where in a discontinuous membrane, the molecular sieve has a major dimension of up to about 100 nanometers, of often in the range of about 5 or 10 to 100 nanometers, preferably between about 10 and 60 to 80, nanometers. Where the molecular sieve barrier is particulate or an island, the aspect ratio (shortest cross-sectional dimension to major dimension) of the particles is generally in the range of about 1:50 to 1:1.

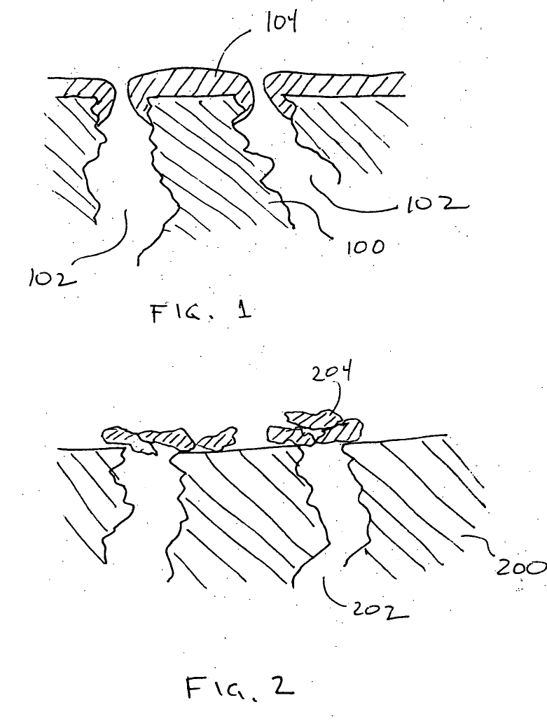

The sieving membranes typically comprise a meso/macroporous structure associated with the molecular sieve. The structure may be the support or may be positioned on a highly porous support. The membranes of this invention contemplate a wide range of structures ranging from a meso/macroporous support on which a coating is placed to reduce the pores to microporosity (see, for instance, FIG. 1) to a multicomponent composite having a support, a meso/macroporous structure in association therewith, and sieving material in association with the meso/macroporous structure (see, for instance, FIG. 5).

The meso/macroporous structure serves one or more functions depending upon the type membrane. It can be the support for the membrane composite, it can be an integral part of forming the microporous barrier, it can be the structure upon which or in which the microporous barrier is located. The meso/macroporous structure can be continuous or discontinuous, and the meso/macroporosity may thus be channels through the material of the meso/macroporous structure or be formed between particles that form the meso/macroporous structure. Examples of the latter are the AccuSep™ inorganic filtration membranes available from the Pall Corp. having a zirconia layer on a porous metal support wherein the zirconia is in the form of spherical crystals.

The meso/macroporous structure preferably defines channels, or pores, in the range of 2 to 500, preferably, 10 to 250, more preferably between about 20 and 200, nanometers in diameter, and has a high flux for both the Permeant and Retentant of the Steric Separation Pair. In more preferred embodiments, the Permeant Flow Index of the meso/macroporous structure is at least about 1, and most preferably at least about 10, and sometimes at least about 1000. The meso/macroporous structure may be isotropic or anisotropic. The meso/macropores may be relatively straight or tortuous.

The meso/macroporous structure may be composed of inorganic, organic or mixed inorganic and organic material. The selection of the material will depend upon the conditions of the separation as well as the type of meso/macroporous structure formed. The material of the meso/macroporous structure may be the same or different than the material for the molecular sieve. Examples of porous structure compositions include metal, alumina such as alpha-alumina, gamma alumina and transition aluminas, molecular sieve, ceramics, glass, polymer, and carbon.

If the meso/macroporous structure does-not so serve, the membrane can contain a porous support for the meso/macroporous structure. The porous support is typically selected on the basis of strength, tolerance for the conditions of the intended separation and porosity. Preferably the composite meso/macroporous structure and porous support has a Permeant Flow Index of at least about 1, and most preferably at least about 10, and sometimes at least about 1000.

Discontinuous Membranes

In accordance to one of the broad aspects of the invention, the high flux membranes are comprised of a discontinuous assembly of microporous barrier having a major dimension less than about 100 nanometers wherein the barrier is in associated with a meso/macroporous structure.

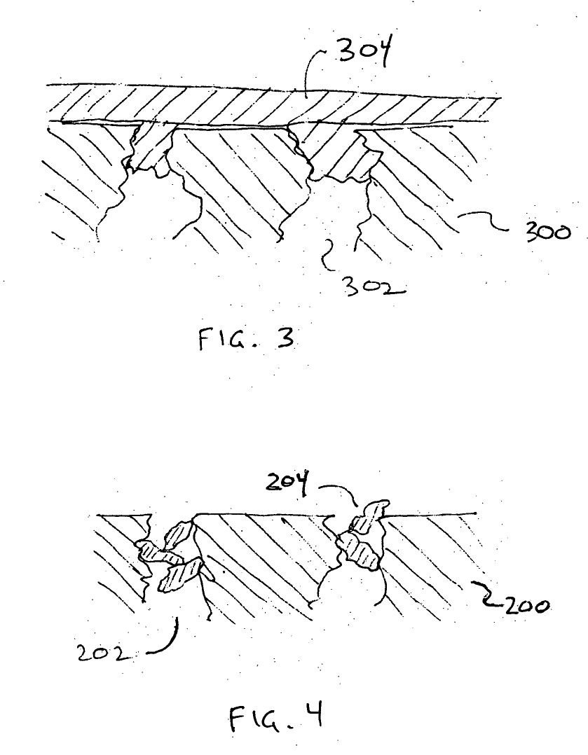

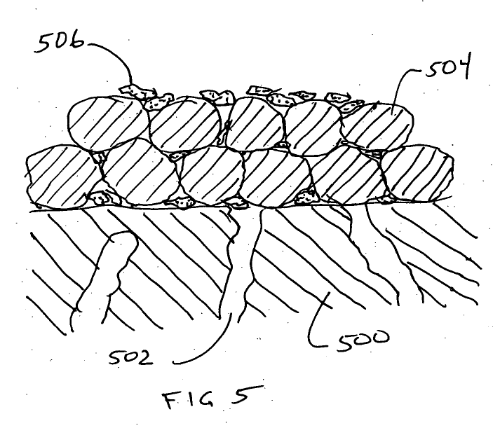

One type of structure is conceptually depicted in FIG. 2 and FIG. 4. In FIGS. 2 and 4, a meso/macroporous support 200 defining pores 202 is associated with barrier particles 204 so as to occlude fluid flow through pores 202 and enhance permeation through the micropores of particles 204. In FIG. 2, the particles are shown as residing at the openings to pores 202 whereas in FIG. 4, the particles are wedged in pores 202.

Typically the size and configuration of the molecular sieve particles and the size and configuration of the meso/macropores in the meso/macroporous structure will be taken into account in selecting the components for the sieving membranes. With more spherical molecular sieve particles, such as silicalite, it is preferred to select a meso/macroporous structure having pores that are close to the same effective diameter. In this manner, the molecular sieve particles, if placed in, or partially in, the pores of the meso/macroporous structure, will provide minimal void space for by-pass. More flexibility exists with platelets and irregular shaped molecular sieve particles as they can overlap with little or no void space. Although overlapping occurs, the permeance of the sieving membrane may not be unduly reduced as the Permeant may be able to pass around an edge of the overlying particle to contact and permeate through the underlying particle. In some instances a combination of molecular sieve configurations may be desirable. For instance, a spherical molecular sieve may be drawn into the pores of a meso/macroporous structure with smaller, more plate-like molecular sieve particles being subsequently introduced. The complementary functions are that the sphere serves as a support for the plate-like particles and the plate-like particles overlap to reduce by-pass. While the molecular sieves will likely be different compositions, and thus have different microporosity size and configuration, the benefit is enhanced separation without undue loss of permeance.

Various techniques exist for providing the molecular sieve particles on or in the meso/macroporous support in a manner that at least partially occludes the meso- or macropores in the support. The specific technique to be used will depend upon the size and configuration of the molecular sieve particles, the size and configuration of the meso/macropores in the meso/macroporous structure, and the desired placement of the molecular sieve in or on the meso/microporous structure.

Especially where molecular sieve is placed on the surface of a meso/macroporous structure to occlude at least a portion of the opening of the pores, the meso/macroporous structure may be wet with a solution, or suspension, of nano-sized molecular sieve. The concentration of molecular sieve in the suspension should be sufficiently low that upon drying, the resulting layer of molecular sieve is not unduly thick. Advantageously at least a slight pressure drop is maintained across the meso/macroporous structure during the coating such that a driving force will exist to draw molecular sieve to any pores in the meso/macroporous structure that have not been occluded. Usually the suspension will be an aqueous suspension, although suspensions in alcohols and other relatively inert liquids can be used advantageously, at a concentration of between about 2 and 30, say 5 and 20, mass percent. Where a pressure differential is used, the pressure differential is generally in the range of 10 to 200 kPa. One or more coats of molecular sieve may be used, preferably with drying between coats. Drying is usually at an elevated temperature, e.g., between about 30° C. and 150° C., for 1 to 50 hours. Vacuum may be used to assist drying. Where zeolites are used as the molecular sieve, calcining, e.g., at a temperature of between about 450° C. and 600° C. may, in some instances, assist in securing the molecular sieve to the meso/macroporous structure. Calcining may also serve to agglomerate the molecular sieve particles and thus reduce voids and the size of voids. Calcining, of course, is not essential to the broad aspects of this invention and is only required where, for example, template resides in the micropores.

Where the molecular sieve is located outside the pores of the meso/macroporous structure, it may be desirable to bond at least a portion of the particles to the surface of the structure. This can be accomplished in a number of ways. For instance, the surface of the structure can be functionalized with hydroxyl groups or other moieties that would be reactive with a zeolitic molecular sieve. For polymeric molecular sieves, the surface may be functionalized with moieties that react, such as addition or condensation, with functional moieties on the polymer. These techniques are well known in the art for other applications.

Similar preparation techniques can be used where it is desired to incorporate at least a portion of the molecular sieve particles in the pores of the meso/macroporous structure. The molecular sieve particles should be of an appropriate size to enter the meso/macropores. A pressure differential may be used to draw barrier particles into the pores or ultrasonication may be used to aid in getting barrier particles into the pores of the meso/macroporous support. The depth of the molecular sieve particles in the pores of the meso/macroporous structure should not be so great as to unduly reduce permeance. Often, any surface deposition of molecular sieve is removed by, e.g., washing.

The following provides an example, which is not in limitation of this invention, to demonstrate that molecular sieve can be introduced into a meso/macroporous support without undue reduction in flux and with stability even though no bonding to the material of the meso/macroporous structure occurs. A ceramic support membrane having 180 nm pores and with dimension of 39.0 mm diameter and 2.0 mm thick obtained from Ceramics BV (catalogue number: S0.18-D39.0-T2.0-G) exhibits a permeance to n-hexane of 41×10⁻⁸ mol/m²·sec·Pa (C₆ Permeate Flow Index of 0.054 mol/m²·sec) at a pressure differential of 131 kPa. The support exhibits no separation of n-hexane from 2,2-dimethylbutane. A sieving membrane is prepared by embedding about 100 nm silicalite particles (template in the molecular sieve) in the pores of the above ceramic support membrane. The ceramic support membrane having 180 nm pores is cleaned by rinsing with 2-propanol and water to remove surface impurities and then dried at 110° C. for at least 24 hours in a vacuum oven. The cleaned 180 nm ceramic support membrane was immersed in an aqueous solution containing about 4 mass-% nano-silicalite (about 100 nm particle size) in a beaker. The beaker is then ultrasonicated for 20 min to aid in directing nano-silicalite particles into the pores of the ceramic support. The resulting ceramic membrane is dried in vacuum oven at room temperature for at least 2 hours and the particles deposited on the surface of the membrane are removed. Then, the ceramic membrane is immersed in an aqueous solution of about 15-20 mass-% nano-silicalite (about 100 nm particle size) for at least 3 hours in a filter funnel which is connected to high vacuum. After that, the excess nano-silicalite particles on the surface of the ceramic membrane are removed and the surface is carefully cleaned with a tissue. The resulting sieving membrane is dried at room temperature for 24 hours under high vacuum followed by drying at 110° C. for at least 24 hours under vacuum.

To demonstrate that the nano-silicalite particles are introduced into the support and stable for use as a sieving membrane, the sieving membrane is then tested by passing pure 2,2-dimethylbutane and then n-hexane to the feed side of the membrane, again with a 131 kPa pressure differential. The membrane exhibits a permeance to n-hexane of 36×10⁻⁸ mol/m²·sec·Pa (C₆ Permeate Flow Index of 0.048 mol/m²·sec) and the ratio of the rates of permeation of n-hexane to 2,2-dimethylbutane is over 1.1:1.

It is possible to calcine zeolitic molecular sieve in situ in a sieving membrane to remove template. The sieving membrane can be calcined at 550° C. for 6 hours under air (heating rate 2° C./min) in a furnace to produce a calcined sieving membrane containing template-free nano-silicalite particles inside the pores of the ceramic support membrane. The calcined sieving membrane exhibits a permeance to n-hexane of 40×10⁻⁸ mol/m²·sec·Pa (C₆ Permeate Flow Index of 0.052 mol/m²·sec) and the ratio of the rates of permeation of n-hexane to 2,2-dimethylbutane is 1.1:1. Thus the calcination does not adversely affect the permeance of the sieving membrane.

As can be readily appreciated, the selection of the meso/macroporous support and the 100 nanometer silicalite particles, which are relatively spherical, will result in large voids between the particles in the 180 nanometer pore, and thus very low C₆ Flow Ratios are expected.

Another type of discontinuous membrane is depicted in FIG. 5. A porous support 500 has channels 502. A layer of, e.g., zirconia spheres 504 provides a meso/macroporous structure. This structure is similar to that of the AccuSep™ inorganic filtration membranes available from the Pall Corp. Often, these types of filtration membranes have very uniform size and distribution of zirconia particles and can thus provide a meso/macroporous structure of relatively uniform size and configuration.

Moreover, as the layer of zirconia particles can be relatively thin, high flux can be achieved. Microporous barrier particles 506 are provided in the interstices of the zirconia spheres. As depicted, the zirconia spheres may be in the order of 400 to 800 nanometers with the barrier particles being less than about 100 nanometers in major dimension.

The sieving membrane can be prepared using any suitable technique including those discussed above. The configuration of the meso/macroporous structure enhances the sieving membrane preparation options. For instance, the particle size of the molecular sieve may be such that it wedges between the close packed spheres of zirconia. Thus, the molecular sieve particle can be physically more secure than with a smoother surfaced meso/macroporous support such as conceptualized in FIG. 2. Alternatively or in addition, the molecular sieve particles may be of a configuration that the pass into voids among the zirconia spheres. Again, additional physical security of the molecular sieve particles is provided.

In addition or alternatively, molecular sieve material can be synthesized in situ. The synthesis may provide discrete particles or islands between other structure such as the meso/macroporous structure or other particles.

For example, with zeolitic molecular sieves, silica, which may have a particle size of between about 5 and 20 nanometers, can be provided in or on the meso/macroporous structure. The silica, due to the active hydroxyls on the surface, serves as a nucleating site for a zeolite-forming, precursor solution, and layers of zeolite can be grown on and between the silica particles. Other materials than silica particles can be used as nucleating sites including other molecular sieves or seed crystals of the same zeolite. The surface of the meso/macroporous structure can be functionalized to provide a selective location for zeolite growth. Some zeolites have self nucleating properties and thus may be used in the absence of nucleating sites. Examples of these zeolites are FAU and MFI. In these situations, it may be desired to maintain the precursor solution under zeolite forming conditions for a time sufficient that growth of the zeolite starts prior to contacting the precursor solution with the meso/macroporous structure.

The AccuSep™ inorganic filtration membranes and similar types of meso/macroporous structures are particularly advantageous for synthesizing growth of molecular sieve material, including polymeric and zeolitic, since the meso/macroporous structure can be thin thereby avoiding undue thicknesses of molecular sieve being grown. Further, the zirconia is relatively inert to zeolite-forming precursor solutions and synthesis and calcination conditions, making it a preferred meso/macroporous structure for this type of sieving membrane.

Polymeric molecular sieves can be synthesized in the meso/macroporous structure. One method for synthesizing a small polymeric molecular sieve is to functionalize nano-particles and/or the meso/macroporous structure with a group that can react with an oligomer such as through a condensation or addition reaction. For instance, the functional groups may provide a hydroxyl, amino, anhydride, dianhydride, aldehyde, amic acid, carboxyl, amide, nitrile, or olefinic moiety for addition or condensation reaction with a reactive moiety of an oligomer. Suitable oligomers may have molecular weights of 30,000 to 500,000 or more and may be reactive oligomers of polysulfones; poly(styrenes) including styrene-containing copolymers; cellulosic polymers and copolymers; polyamides; polyimides; polyethers; polyurethanes; polyesters; acrylic and methacrylic polymers and copolymers; polysulfides, polyolefins, especially vinyl polymers and copolymers; polyallyls; poly(benzimidazole); polyphosphazines; polyhydrazides; polycarbodiides, and the like.

The synthesis in situ of the molecular sieve, whether it be inorganic or organic, can be under suitable conditions. A preferred technique involves conducting the synthesis while drawing the reactant solution, e.g., the precursor solution or oligomer solution through the meso/macroporous structure. This technique provides the benefit of directing the reactant solution to voids that have not been occluded as well as limits the extent of growth of the molecular sieve as no fresh reactant will be able to enter the reaction site once the molecular sieve has occluded the meso- or macropore.

FIG. 8 is a conceptual representation of a discontinuous membrane where zeolite is grown on substrate particles. A macroporous structure 800 has substrate particles 802 thereon. Zeolite growth 804 occurs on substrate particles 802.

By way of example and not in limitation, an AccuSep™ inorganic filtration membrane available from the Pall Corp. (pore size of 100 nanometers) is cleaned with distilled water and dried. An aqueous solution of LUDOX™ silica available from Sigma-Aldrich having a particle size of about 9 nanometers (about 5 mass percent) is passed through the membrane for 20 minutes with a pressure differential of about 70 kPa. The exterior of the membrane is lightly washed with deionized water with no pressure differential so as to selectively remove silica from the outer portion of the zirconia meso/macroporous structure. The membrane is then dried in air at 110° C. for about 24 hours.

A precursor solution comprising 6.34 mass parts of tetraethylammonium hydroxide, 3.17 mass parts of P₂O₅, and 186 mass parts of water per part of alumina. The precursor solution is heated to a temperature of about 100° C. and then drawn through the membrane initially a pressure drop of about 200 kPa through the membrane. When the flow of the precursor solution has essentially stopped, the membrane is withdrawn from the solution and washed with deionized water. It is dried at 110° C. in an air atmosphere for about 24 hours and then calcined at 550° C. for 6 hours (air atmosphere) with a heating and cooling rate of about 2° C. per hour.

Enhancing Selectivities of Discontinuous Sieving Membranes

Where higher selectivities are sought, the contact between the microporous barrier particles may still provide for undue amounts of bypass. Several techniques are provided by this invention to enhance the selectivities of the membranes without unduly reducing the flux of the Permeant.

One generic technique for enhancing the selectivity of a sieving membrane is to agglomerate adjacent particles of molecular sieve to reduce or substantially eliminate voids between the particles and between the particles and walls of the pore structure in the meso/macroporous structure. Because the particles are nano-sized and the number of adjacent particles can be relatively few, the agglomeration can occur while still retaining desirable Permeant Flow Rates. For polymeric molecular sieves that are thermoplastic, the agglomeration can occur by heating to a temperature where agglomeration occurs but no so high as to lose either its microporous structure or its ability to provide the desired occlusion of the meso- or macropore of the meso/macroporous structure. Agglomeration can also be accomplished by calcining zeolitic molecular sieves. Calcining tends to agglomerate small zeolite particles, especially particles that are neither silated nor otherwise treated to reduce the tendency to agglomerate. The temperature and duration of the calcining will depend upon the nature of the zeolitic molecular sieve. Usually temperatures of between about 450° C. and 650° C. are employed over a period of between about 2 and 20 hours.

The agglomeration technique may be used with respect to molecular sieve particles that are on the surface of the meso/macroporous structure as well as those within the pores of the structure. Most preferably, agglomeration is used when the molecular sieve particles are located within the meso- or macropores of the meso/macroporous structure such that the major dimension of the agglomerate is less than about 200, preferably less than about 100, nanometers. The agglomeration may be effected with or without a pressure differential across the membrane. Preferably a pressure differential is used to assist in reducing voids through which fluid can by-pass the molecular sieve.

Another generic technique where the discontinuous assembly of barrier defines voids is to at least partially occlude at least a portion of the voids by a solid material therein. Preferably the solid material is a polymer or inorganic material. The solid material may simply reside in the void or it may adhere or be bonded to the molecular sieve or meso/macroporous structure. The solid material may be a particle or oligomer that may be preformed and then introduced into the voids or it may be formed in situ.

In one aspect, the solid material provides a “mortar” with the microporous barrier particles. The mortar is typically a suitable polymeric material that can withstand the conditions of the separation. Representative polymers include polysulfones; poly(styrenes) including styrene-containing copolymers; cellulosic polymers and copolymers; polyamides; polyimides; polyethers; polyurethanes; polyesters; acrylic and methacrylic polymers and copolymers; polysulfides, polyolefins, especially vinyl polymers and copolymers; polyallyls; poly(benzimidazole); polyphosphazines; polyhydrazides; polycarbodiides, and the like. Preferred polymers are those having porosity such as PIMs (see WO 2005/012397) and polymers in which porosity has been induced by pore forming agents. These polymers have pores that may be 0.3 or more, preferably at least about 1, nanometer in major dimension and hence allow for fluid flow to and from the barrier particles.

It is not necessary that all particles be encased in the mortar. Often the average thickness of the mortar layer is less than 100 nanometers, and is preferably no more than about the major dimension of the particles. If too much mortar is used, a mixed membrane structure may result, and flux unduly penalized. Hence, the mass ratio of barrier particles to mortar often is in the range of between about 1:2 to 100:1, preferably between about 3:1 to 30:1.

The mortar and particles may be admixed, e.g., in a slurry, and then placed in association with the microporous structure, or may be provided after deposition of the particles. The polymer may be formed in situ at the region containing the barrier particles. The barrier particle may be inert to the polymerization or may have active sites to anchor a polymer. For instance, the particle may be functionalized with a reactive group that can bind with the polymer or with monomer undergoing polymerization, say, through a condensation or addition mechanism such as discussed above.

A concern is that the mortar occludes the micropores of the molecular sieve. With highly porous polymer such as the PIMs, the effect of any occlusion can be attenuated. Often, the amount of polymer used for the mortar and its molecular weight and configuration is such that insufficient polymer is present for encapsulating all the molecular sieve particles. Frequently, the mass ratio of polymer to molecular sieve is between about 0.01:1 and 0.3:1. The weight average molecular weight of the polymer is sometimes in the range of about 20,000 to 500,000, preferably, between about 30,000 and 300,000.

The mortar may be other than polymeric. For example, where the molecular sieve is a zeolite, a silicon tetraalkoxide can react with the zeolite and can through hydrolysis form a silica framework or mass between the molecular sieve particles. Usually a dilute aqueous solution of silicon tetraalkoxide is used, e.g., containing between about 0.5 and 25 mass percent silicon tetraalkoxide, to assure distribution. The functionalization of the zeolite with silicon tetraalkoxide also is useful as a cross-linking site with organic polymer, especially those containing functional groups such as hydroxyl, amino, anhydride, dianhydride, aldehyde or amic acid groups that can form covalent bonds with organosilicon alkoxide. Also, the same or different zeolite may be grown between the zeolite particles and the zeolite particles and the meso/macroporous structure using the techniques described above.

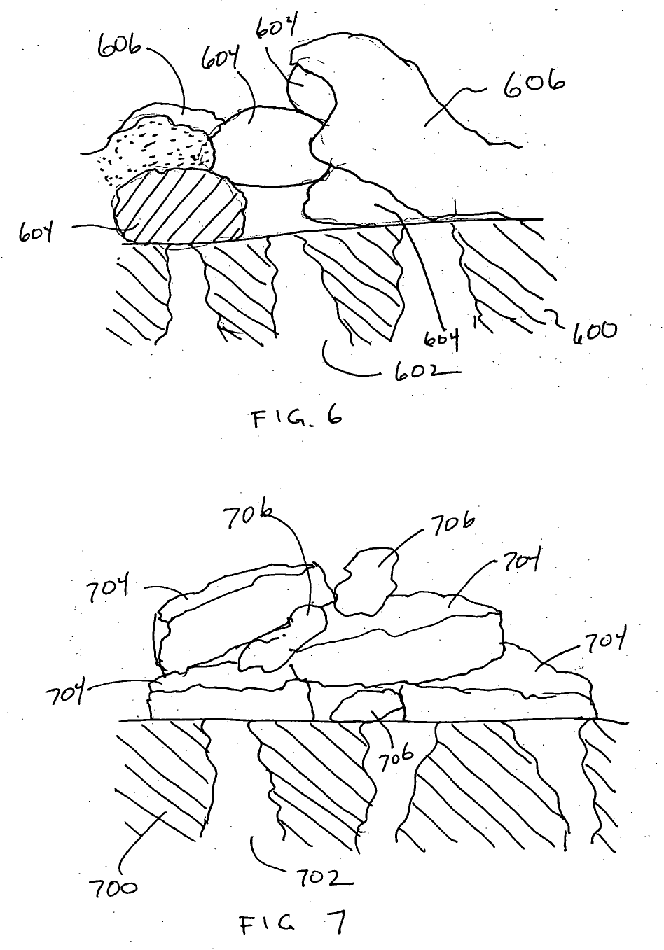

FIG. 6 is a representation of one possible structure using mortar. FIG. 6 is not in limitation of the invention. Macroporous support 600 with pores 602 serves as the support for microporous barrier particles 604.

By way of example and not in limitation, a sieving membrane is prepared by embedding about 100 nm silicalite particles (template in the molecular sieve) in the pores of a ceramic support membrane having 180 nm pores and with dimension of 39.0 mm diameter and 2.0 mm thick obtained from Ceramics BV (catalogue number: S0.18-D39.0-T2.0-G). The ceramic support membrane having 180 nm pores is cleaned by rinsing with 2-propanol and water to remove surface impurities and then dried at 110° C. for at least 24 hours in a vacuum oven. The cleaned 180 nm ceramic support membrane was immersed in an aqueous solution containing about 4 mass-% nano-silicalite (about 100 nm particle size) in a beaker. The beaker is then ultrasonicated for 20 min to aid in directing nano-silicalite particles into the pores of the ceramic support. The resulting ceramic membrane is dried in vacuum oven at room temperature for at least 2 hours and the particles deposited on the surface of the membrane are removed. Then, the ceramic membrane is immersed in an aqueous solution of about 15-20 mass-% nano-silicalite (about 100 nm particle size) for at least 3 hours in a filter funnel which is connected to high vacuum. After that, the excess nano-silicalite particles on the surface of the ceramic membrane are removed and the surface is carefully cleaned with a tissue. The resulting sieving membrane is dried at room temperature for 24 hours under high vacuum followed by drying at 110° C. for at least 24 hours under vacuum. The sieving membrane is calcined at 550° C. for 6 hours under air (heating rate 2° C./min) in a furnace to produce a calcined sieving membrane containing template-free nano-silicalite particles inside the pores of the ceramic support membrane.

A cross-linkable polyimide-organosilane polymer is prepared by dissolving 5 mass parts of the polyimide (MW of about 32,000) in 100 mass parts of tetrahyrofuran. The polyimide is poly((4,4′-hexafluoroisopropylidene)-diphthalic anhydride-diaminomesitylene-3,5-diaminobenzoic acid). About 1.3 mass parts of 3-isocyanatoproplytriethoxysilane is added to the solution. The polymer solution is heated at about 60 for about 24 hours.

A solution of 2 mass percent silicon tetraethoxide in tetrahydrofuran is passed through the above calcine sieving membrane for about 1 hour at a pressure differential of about 100 kPa. The membrane is once again air dried at 110° C. for about 24 hours. About 5 mass parts of glacial acetic acid and an additional 200 mass parts of tetrahydrofuran are mixed into the polymer solution and the solution is passed through the membrane with the pressure differential of about 100 kPa for a period of 5 hours. The rate at which the solution passes through the membrane quickly drops as the cross-linking occurs. The sieving membrane is then dried at about 110° C. for about 50 hours in vacuo. The C₆ Permeate Flow Ratio is improved while still achieving a desirable C₆ Permeate Flow Index.

In another illustration, a PIM is prepared by the procedure set forth in Example 10 of WO 2005/012397 except that 2,3,5,6-tetrafluoroterephthalonitrile is used in lieu of 2,3,5,6-tetrachloroterephthalonitrile. A solution is prepared of about 5 mass parts of PIM in 100 mass parts of tetrahydrofuran. To this solution is added 25 mass parts of colloidal, silated and calcined zeolite Y (FAU) having an average particle size of about 40 nanometers. The solution is passed through an AccuSep™ inorganic filtration membranes available from the Pall Corp having a nominal pore diameter of about 100 nanometers. The filtration membrane was first washed with a solution of 2-propanol and water and dried. A pressure drop of about 100 kPa is maintained across the filtration membrane for a period of about 4 hours. The membrane is then dried at 110° C. in vacuo for 48 hours.

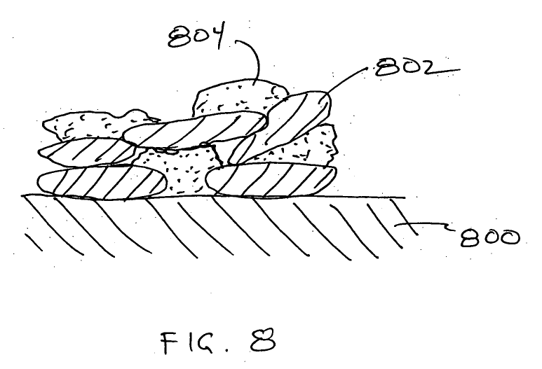

Yet another approach to reducing bypass is to use two or more sized particles in forming the barrier-containing layer. If, for example, the microporous barrier particles are generally spherical with a nominal major dimension of 60 nanometers, the regions between the particles can be sizable and enable bypass. Incorporating configurationally compatible particles in these regions can hinder fluid flow and thus result in a greater portion of the fluid being directed to the barrier particles for the selective separation. FIG. 7 is a schematic depiction of one possible structure where a macroporous support having pores 702 has thereon discrete particles of microporous barrier particles 704. Plugging solid particles 706 occlude at least a portion of the open regions between the barrier particles.

The configuration of the barrier particles will depend upon the type of barrier particle used. A microporous zeolitic molecular sieve particle having a major dimension of less than about 100 nanometers will likely have a defined configuration due to its crystalline structure. Some zeolites tend to have a platelet-type configuration whereas others, such as AIPO-14, have a rod-like structure. Similarly, polymeric, ceramic, glass and carbon molecular sieve particles may have configurations that are not readily changed. Hence, the configuration of the open regions between particles can vary widely.

In one embodiment of this aspect of the invention, the configurationally compatible particles are selected to achieve at least partial occlusion of the region. Thus, for spherical barrier particles rod shaped or much smaller configurationally compatible particles may be desired.

The configurationally compatible particles may be of any suitable composition given the size and conditions of operation. The particles may be polymeric, including oligomeric; carbon; and inorganic such as fumed silica, zeolite, alumina, and the like.

Especially with some zeolitic molecular sieve materials, making particles less than 100 nanometers is troublesome. Moreover, even with the use of seed crystals, the particle size may be larger than desired. Another embodiment in making a discontinuous barrier membrane is to synthesize the zeolite in open regions between particles (substrate particles) having a major dimension less than about 100 nanometers. Accordingly, the major dimension of the microporous barrier can be less than about 100 nanometers. The substrate particles serve as a nucleating site for the zeolite formation and thus are selected from materials having capability of nucleating the growth of the zeolite. Examples of such materials are silica, especially silica having a major dimension of between about 5 and 50 nanometers and other zeolites having major dimensions less than about 100 nanometers. The use of fumed silica as the substrate particle is particularly useful for making an AIPO microporous barrier.

The growth of the zeolite on the substrate particle may occur before or after the substrate particle is used in forming the membrane composite.

Advantageously, the growth of the zeolite on the substrate particles occurs while drawing the synthesis liquor through the composite. This technique helps ensure that the growth occurs not as a layer on top of the particles, but in the interstices between the particles. The pressure drop increases as the zeolite growth occurs, and the pressure drop can be used as an indicator when adequate zeolite formation has occurred.

FIG. 8 is a conceptual representation of a discontinuous membrane where zeolite is grown on substrate particles. A macroporous structure 800 has substrate particles 802 thereon. Zeolite growth 804 occurs on substrate particles 802.

In some instances it may be feasible to grow zeolite in the channels of a microporous structure without the use of substrate particles, i.e., the walls of the microporous structure provide the nucleating sites to initiate the formation of the zeolitic structure. Again, the extent of zeolite growth has to be controlled such that undue thicknesses of zeolite do not occur. Preferably the growth of the zeolite occurs while drawing the synthesis liquor through the microporous structure.

Other Types of High Flux Membranes

The following discussion is with respect to types of high flux membranes suitable for separations of hydrocarbons. These membranes include membrane structures the same as and in addition to those discussed in the preceding section on particulate and island membranes.

High flux membranes can be achieved through at least one of the following techniques: first, using a larger micropore than required for Permeant, e.g., normal paraffin to pass, thereby allowing some of the Retentate, e.g., branched paraffin, to pass through the membrane; and second, using an extremely thin microporous barrier. The membranes may be continuous or discontinuous.

In the former, it is realized that with larger pores, the membrane will likely lose selectivity. However, in many applications of the membranes, sacrifices in selectivity can be tolerated provided that high flux is obtained. In some instances, the relative permeation rates of, say, normal hexane and branched hexane may be substantially the same, yet adequate separation may be achieved. If, for instance, a feedstock contains 3 moles of branched hexane per mole of normal hexane, and 1.5 moles of branched hexane permeate per mole of normal hexane, the permeate will still be richer in normal hexane than in the feedstock and the retentate will be richer in branched hexane than in the feedstock. This is particularly the case where the presence of, say, normal hexane within a micropore selectively hinders the entry of branched hexane into the micropore.

For example, MFI has typically been proposed for the separation of normal from branched hydrocarbons such as n-butane from i-butane or n-pentane from i-pentane. The micropore size of MFI, however, is such that the normal alkane is also hindered in its entry into the micropore. A similar membrane but made from FAU having a pore size of about 8 Å exhibits a higher C₆ Permeate Flow Index with a still acceptable C₆ Permeate Flow Index. Thus, as compared to an MFI membrane such as disclosed in example 1 of WO 2005/0049766, a similar FAU would have substantially higher flux and a gasoline fraction of about 91 RON could still be obtained.

For the other type of high flux membrane where the microporous barrier is thin, whether it be a continuous film or discontinuous, the barrier may contain defects, or openings, between particles or islands, in discontinuous membranes and in the thin layer in continuous membranes, through which the Steric Separation Pair can pass with little or no selective separation. Again, the selectivity of separation suffers but may be acceptable for commercial application due to the high flux obtainable. The defects, or openings, of course, can, if desired, be minimized in one or both of number and size, thereby further enhancing the selectivity of the sieving membrane.

In a continuous membrane, the thinness of the sieving layer is important to achieving the high flux. However, as the thickness of the sieving layer decreases, the difficulties in obtaining and retaining a defect-free layer increase. As the processes of this invention do not require high selectivity, the membranes can contain minor defects, i.e., those having a relatively small effective diameter. Larger defects are less tolerable and to the extent present, are relatively infrequent so as to maintain the sought C₆ Permeate Flow Ratio. For instance, with a membrane having a ZSM-5 (MFI) barrier layer, a C₆ Permeate Flow Ratio of 1.5 can be achieved if only about one-third of the fluid passes through the barrier layer. Other suitable zeolites for making very thin continuous films include X, A, beta and L.

By way of example, one technique for preparing a composite membrane is to form within or on a meso/macroporous substrate, molecular sieving structures. The meso/macroporous substrate may be any suitable inorganic material which exhibits suitable strength to withstand the differential in pressure and temperatures of operation. Examples of porous substrate compositions include metal, alumina such as alpha-alumina, gamma alumina and transition aluminas, molecular sieve, ceramics, glass, polymer, and carbon. Particularly useful are high flux ultrafiltration membranes having mesopore openings. The porous substrate is preferably highly porous and preferably has a C₆ Permeate Flow Index of at least about 1, preferably at least about 10. The porous substrate will often have pores or openings in the range of 2 to 100, preferably about 20 to 50, nanometers. The pores or openings may be substantially straight or tortuous and may be defined by a passage through a solid or through void spaces between particles of the substrate. The AccuSep™ inorganic filtration membranes and Memralox™ membranes available from the Pall Corp. are examples of ultrafiltration membrane having desirably high flux. Other commercially available ultrafiltration membranes are DuraMem™ ceramic membranes available from CeraMem Corporation having a pore size of 10 nm (made from titania) or pore size of 50 nm (made from silica or γ-alumina).

In preferred embodiments, defects in the substrate are repaired prior to depositing the barrier layer or precursor to the barrier layer. In another embodiment, the substrate may be treated with a silica sol to partially occlude pores and facilitate deposition of the barrier layer or precursor to the barrier layer. The silica particles will still provide sufficient space between their interstices to allow high flux rates. Another technique is to coat the support with silicon rubber or other polymer that permits high flux but occludes defects in the support or in the barrier.

One method to form a barrier layer is to place a molecular sieve precursor liquid on the porous substrate. The precursor is permitted to crystallize under hydrothermal crystallization conditions, after which the porous substrate is washed and heated to remove residual organic material. The molecular sieve material resides primarily in and occludes the pores of the porous substrate. As is known in the art, zeolitic molecular sieve can grow not only as a continuous layer over the porous substrate, but also in the pores, thereby increasing the distance through which a Permeant must pass. Techniques that have been proposed to minimize this internal growth have been to fill the pores with wax or silica prior to the deposition of the continuous layer of molecular sieve, but also to coat the support with a polymer layer prior to the synthesis of the zeolite film.

Another method for preparing a membrane suitable for use in accordance with the processes of this invention involves depositing a thin layer of molecular sieve on a porous support such as a polymeric support or an inorganic support as described above. In preferred embodiments of these membranes, the porous substrate is highly porous and preferably has a C₆ Permeate Flow Index of at least about 1, preferably at least about 10. The porous substrate will often have pores or openings in the range of 2 to 200, preferably about 20 to 100, nanometers. The structure of the polymeric support may be isotropic, but preferably is anisotropic. The pores or openings may be substantially straight or tortuous and may be defined by a passage through a solid or through void spaces between particles of the substrate. Typical polymeric supports include polyimides, polyacrylonitrile, polycarbonates, polyetherketones, polyethersulfones and polysulfones.

The molecular sieve deposited is generally of a relatively small particle size, e.g., about 20 to 50 nanometers in major direction. The application of the molecular sieve to the support may be effected in any convenient manner. For instance, the molecular sieve may be in an aqueous slurry and applied to the membrane in the form of a thin coating, e.g., a slurry containing from about 5 to 50 mass-percent molecular sieve with the coating thickness being less than about 200, preferably between about 50 and 100, nanometers prior to drying. The depositing process can include, if desired, maintaining one side of the porous support at lower pressure to assist in placing the molecular sieve in the pores of the support. Where the molecular sieve is not securely maintained on the support, e.g., lodged in pores, the coating composition may contain one or more components to serve as adhesives provided that they do not occlude the pore structure of the molecular sieve. Adjuvants include one or more of polyamides, polyvinylalcohols, polyvinylacetate, silicone rubbers, and polyacrylates.

The molecular sieve on polymer support membranes or polymeric supports themselves may also be pyrolyzed in a vacuum furnace to produce a carbon membrane. For such membranes containing molecular sieves, the pore structure of the carbon support is preferably of sufficient diameter to minimize the resistance to the flow of fluids with the molecular sieve structure doing the separation. The temperature of the pyrolysis will depend upon the nature of the polymer support and will be below a temperature at which the porosity is unduly reduced. Examples of polymeric supports include polyimides, polyacrylonitrile, polycarbonates, polyetherketones, polyethersulfones and polysulfones, and prior to pyrolysis, the supports have pores or openings in the range of 2 to 100, preferably about 20 to 50, nanometers.

FIG. 3 is a conceptual representation of this type of membrane. A mesoporous support with mesopores 302 has a thin zeolite film coating 304. As shown, some growth of zeolite has occurred into the mesopores of the support. Although this increases the thickness of the zeolite layer through which the Permeant must pass, an ancillary benefit is that the mesopore is not open to by-pass in the event that the film cracks or otherwise has a defect. Especially with very thin films, it may be desired to allow some growth of molecular sieve into the mesopores of the support in anticipation of the thin film either not being completely formed or degrading during further processing or handling or use such that selectivity is retained.

Another technique for providing a composite high flux membrane is to deposit by chemical vapor deposition a thin layer on the surface of a highly porous support which may be polymeric or inorganic of the types disclosed above. The deposited material serves to provide a localized reduction of the pores or openings through the support to a size which permits the desired sieving without unduly reducing the diameter of the remaining pore structure in the support. Examples of vapor depositable materials include silanes, para-xylylene, alkylene imines, and alkylene oxides. Another technique for reducing pore size is to deposit a coke layer on the meso/macroporous structure. For instance, a carbonizable gas such as methane, ethane, ethylene or acetylene can be contacted with the structure at sufficiently elevated temperature to cause coking. The preferred porous supports are ultrafiltration membranes having pore sizes of between about 1 and 80, preferably between about 2 and 50, nanometers.

FIG. 1 is a conceptual representation of a sieving membrane made by depositing a coating that reduces the size of the mesopores to micropores. Meso/macroporous support 100 defining mesopores 102 has deposited thereon a poly(para-xylylene) coating 104. The vapor deposition of para-xylylene is typically very uniform and pinhole free and thus the depth of the coating can be controlled.

One technique for depositing molecular sieves on a porous support is to provide a relatively uniform, dilute suspension of molecular sieve in a viscous liquid or solid polymer such that when the liquid or polymer is removed, e.g., by calcination, a thin, highly uniform coating of molecular sieve remains. By way of example, a suspension of molecular sieve (preferably, about 1 to 10 mass-percent) in hydrocarbon that is normally solid at room temperature such as dodecane is prepared and applied as a coating on the outside of a hollow tubular, porous support. The temperature of the suspension is such that the viscosity is suitable to maintain the uniform suspension but yet provide the desired thin coating. The coating thickness is usually about 5 to 30 microns. A slight pressure differential is maintained across the wall of the tube (about 5 to 30 kPa) such that more of the coating is drawn into any large defects in the support than into the micropores of the molecular sieve. The support is then dried and calcined to remove the hydrocarbon.

As the membranes need not exhibit high C₆ Permeate Flow Ratios to be useful for many applications, any technique that increases resistance to flow through the defects will serve to improve membrane performance. For instance, a silica sol overlay coating may be used to occlude interstitial openings between the molecular sieve crystals or remaining large pores in the support regardless of how the membrane is prepared.

Another technique to occlude large pores is to provide on one side of the barrier layer a large, reactive molecule which is not able to permeate the subnaometer pores of the barrier and on the other side a cross linking agent. The major defects, and to some extent the minor defects become filled with the large, reactive molecule and are fixed by crosslinking. The unreacted large molecule component can then be removed as well as unreacted cross linking agent. The large molecule may be an oligomer or large molecule.

Membranes and Separators

The membranes of this invention may be in any suitable form such as hollow fibers or tubes, sheets which may be flat, spiral wound, corrugated, and the like. The form of the membranes will often depend upon the nature of the membrane itself and the ease of manufacturing the form. The membranes can be assembled in a separator in any suitable configuration for the form of the membrane such as bundled fiber or tubes, flat plates or spiral wound sheets.

The design of the separator may provide for co-current, counter-current or cross-current flows of the feed on the Retentant side of the membrane and the Permeant. If desired, the separator may be adapted to provide for a sweep fluid on the Permeant side of the membrane.

The form of the membranes and the design of the separator can be influenced by the nature of the components in the feeds and the type of separation mechanism used. For instance, with gas permeation and pervaporation, a pressure drop is usually required to maintain an attractive partial pressure driving force for the sought permeation. Hence the membranes and the separator need to be able to withstand the pressures required. Similarly, with some separations, elevated temperatures may be beneficial, and the selection of the membranes and the design of the separator need to reflect the intended temperature of operation. With separations from liquid to liquid phases, concentration gradients, not partial pressure gradients, serve as the driving force and the membranes and separator design can be selected based upon different criteria such as facilitating fluid flow and distribution in the separator.

Uses of High Flux Membranes

The membranes of this invention may be used for the separation of one or more components (Permeants or Retentants) from a wide variety of fluid streams containing such components and other components having different rates of permeation through the membranes. The separations that are preferred are those in which the molecular sizes of the components in the feed stream differ. But as said above, chemical and other physical factors may also influence the selectivity of the separation.

The feed to the membrane (retentate side) may be liquid, gas, mixed phase or supercritical fluid. The fluid on the permeate side may also be liquid, gas, mixed phase or supercritical fluid and may be in a different phase than the feed.

The processes of the invention are broadly applicable to separations of Steric Separation Pairs from various feed compositions which may be bicomponent (containing just the Steric Separation Pair) or multicomponent which may contain components of larger and smaller molecular size. The molecules that may be involved in the separations can be those that are normally gases, such as hydrogen, helium, oxygen, nitrogen, argon, carbon dioxide, carbon monoxide, hydrogen sulfide, carbonyl sulfide, sulfur dioxide, ammonia and lower hydrocarbon containing compounds such as methane, ethane, ethylene, acetylene, propane, propylene, dimethyl ether, ethylene oxide, methylethyl ether, methylchloride, fluorocarbons and the like; and liquids such as water and hydrocarbon-containing compounds such as butane, n-butene, i-butene, butadiene, and higher aliphatic and aromatic hydrocarbons; oxygenated hydrocarbons such as methanol, ethanol, 1-propanol, 2-propanol, ethylene glycol, propylene glycol, 1,3-propanediol, glycerol, methylethyl ketone, acetic acid, ethylacetate, methyl acrylate, methyl methacylate, tetrahydrofuran, and similar and higher molecular weight compounds; other heteroatom hydrocarbons such as amides, nitriles, pyridines, pyrrolidones, mercaptans, etc.; and normally solid compounds that can be liquid, gaseous or supercritical fluid or dissolved under the conditions of separation such as higher aliphatic and aromatic hydrocarbon-containing compounds such as higher alkanes such as cetane, higher esters and acids such as alkyl stearates, higher alkylbenzenes such as dodecylbenzene; and the like.

The processes of this invention are particularly attractive for treating large volume process streams such as found in refineries and large scale chemical plants, especially where beneficial process improvements can be obtained even with relatively low separation such as in recovering normal paraffins from an isomerization reactor effluent for recycle to the reactor, in separating normal paraffins from branched and cyclic paraffins and aromatics to provide an enhanced feed to a steam cracker, and in separating alkylbenzenes from linear and lightly branched aliphatics and from benzene. The processes of this invention may also be beneficial for carbohydrate and biomass separations in the food and synthetic fuels industries such as the separations of mono-, di-, tri- and polysaccharides.

The separation may have as its objective either concentration or selective permeation:
In a concentration mode, smaller components are removed from the feed mixture to provide a retentate that is relatively free from the smaller components. In such a mode, the selectivity of the membrane relates only to the degree of recovery of the Retentant. As the selectivity of the membrane decreases, all other things equal, the portion of the desired Retentant compound that passes through the membrane increases. Yet, a relatively pure Retentant can be obtained.
In the selective permeation mode, the purity of the Permeant is a major issue. In general, more selective membranes are more desirable. Nevertheless, a more concentrated mixture of the Permeant compound may be desirable, especially to reduce the size, energy requirement or debottleneck other unit operations. Moreover, in some chemical and refining processes, any concentration of the intended Permeant compound can be beneficial provided that a high portion of that compound is recovered in the permeate.

The relative concentrations of the Permeant and Retentant (Steric Separation Pair) in a feed to the membranes of this invention may vary widely, e.g., in a mole ratio of from about 1:100 to 100:1, preferably from between about 10:1 to 1:10. Other components may be in the feed. The membrane may exhibit the same or higher or lower permeance for these components. Especially with petroleum refinery streams, the feeds with comprise many components. Frequently the Permeant and Retentant of the Steric Separation Pair comprise at least about 15, preferably at least about 20, mass percent of the feed.

Isomerizations

One attractive use for the membranes of this invention, including those having lower separation capabilities, is in isomerization processes where a non-equilibrium mixture is reacted to provide an isomerate containing a mixture at or near equilibrium distribution. Contacting the reaction effluent with a sieving membrane of this invention can provide a retentate stream enriched in one or more of the isomers and a permeate stream enriched in one or more of the other isomers. The less desired fraction can, if desired, be recycled to the isomerization zone. Isomerizations of alkanes and alkenes of 4 to 30 carbon atoms such as butane isomerization and isomerization of light naphtha feeds to make higher octane fuels, aromatics such as xylenes, and the like, are practiced in commercial scale.

Xylene Isomerization

Xylenes, when subjected to isomerization, form mixture of para-xylene, ortho-xylene and meta-xylene. While each has commercial value, the biggest demand has been for the para-xylene isomer. Para-xylene is about 25 percent of the equilibrium mixture, ortho-xylene is in the range of about 22 percent of the equilibrium mixture and meta-xylene constitutes the balance. Commercially practiced processes involve the selective removal of para-xylene by selective crystallization or sorption. These unit operations provide highly pure para-xylene. The balance of the xylenes, after removal of any ortho- or meta-xylene desired, is isomerized to generate more para-xylene and the mixture is recycled for recovery of the para-xylene together with fresh para-xylene-containing feedstock. The recycle loop also typically contains separation operations down stream of the isomerization reactor such as a toluene splitter to remove toluene from the xylenes and a xylene column to remove heavies from C₈ aromatics. In most commercial processes, other components such as ethylbenzene are present in the recycle loop, and components may be formed during the isomerization such as heavies and naphthenes and lower hydrocarbons.

A particularly attractive use of the membranes of this invention, including those membranes having lower selectivities, is enriching at least a portion of the recycle stream. This enriched stream, when combined with the remaining feed to the selective sorption or crystallization unit operation, will improve the efficiency since the feed will contain a greater concentration of para-xylene. Advantageously, the membrane has a Permeant Flow Index where para-xylene is the Permeant, of at least about 0.1, preferably at least about 1, gram mole per square meter per second. The Permeant Flow Ratio (para-xylene and meta-xylene are the Steric Separation Pair) can be relatively low yet still provide a substantial process benefit. For instance, this Permeant Flow Ratio may be in the range of 1.3:1 to 8:1.

While the entire recycle stream can be subjected to the membrane separation, a preferred embodiment is to pass only about 10 to 50 volume percent of the stream (preferably an aliquot portion) to the membrane, with the remainder going to a xylene column for recycle to the selective para-xylene removal unit operation. The membrane separation is operated to recover at least about 70, preferably at least about 90, and sometimes at least about 95, percent of the para-xylene in the slip stream. Thus, the increase in the feed to the isomerization as well as the downstream unit operations such as strippers and deheptanizers, as a result of the retentate being combined with the effluent from the para-xylene recovery unit operation, is minimized. As the xylene-containing isomerate typically contains heavier alkylbenzenes, the total C₉⁺ aromatics in the combined permeate and feed streams to the para-xylene recovery unit operation is preferably less than about 500 parts per million by mass (ppm-m). If C₉⁺ aromatics are contained in the permeate, one or both of the amount of the slip stream and the extent of recovery of para-xylene in the permeate can be reduced to lower the amount of C₉⁺ aromatics in the combined feed to the para-xylene recovery unit operation.

Butane Isomerization

Processes for the isomerization of normal butane to isobutane are widely practiced. The isomerization process proceeds toward a thermodynamic equilibrium. Hence, the isomerate will still contain a substantial concentration of normal butane, usually in the range of a mole ratio of normal butane to isobutane of about 40:60. Membranes of this invention can be used to separate the isomers. For instance, at least a portion of the isomerization effluent can be contacted with a retentate-side of a sieving membrane having a Permeate Flow Index for n-butane of at least about 0.01, more preferably at least about 0.02, and a Permeate Flow Ratio n-butane to i-butane) of at least about 1.25:1, more preferably at least about 1.3:1, and often 1.35:1 to 5:1 or 6:1, under conditions including sufficient membrane surface area and pressure differential across the membrane to provide a retentate fraction containing at least about 80, preferably at least about 90, mass-percent isobutane, and to provide across the membrane at a permeate-side, a permeate fraction having an increased concentration of normal butane, said permeate fraction preferably containing at least about 80, preferably at least about 90, mass-percent of the normal butane contained in the normal butane-containing fraction contacted with the membrane. In preferred aspects, the retentate contains at least about 50, preferably at least about 70, mass-percent of the isobutane contacting the membrane.

The concentration of normal butane in the isomerization feed will not only depend upon the concentration of normal butane in the feedstock but also its concentration in the recycle, if any, and the relative amount of recycle to feedstock, which can fall within a wide range. Often, the isomerization feed has a normal butane concentration of at least about 50, say, between about 60 and 100, preferably about 75 to 90, mass-percent.

In the isomerization zone the isomerization feed is subjected to isomerization conditions including the presence of isomerization catalyst preferably in the presence of a limited amount of hydrogen. The isomerization of normal butane is generally considered a reversible first order reaction. Thus, the isomerization reaction effluent will contain a greater concentration of isobutane and a lesser concentration of normal butane than does the isomerization feed. In preferred embodiments of this invention, the isomerization conditions are sufficient to isomerize at least about 20, preferably, between 30 and 60, mass-percent of the normal paraffins in the combined feedstock and recycle. In general, the isomerization conditions achieve at least about 70, preferably at least about 75, say, 75 to essentially 100, percent of equilibrium for C₄ paraffins present in the isomerization feed. In many instances, the isomerization reaction effluent has a mass ratio of isobutane to normal butane of at least about 1.2:1, preferably between about 1.4 to 2:1.

A pressure drop is maintained across the sieving membrane in order to effect the desired separation at suitable permeation rates. The pressure drop is often in the range of about 0.1 to 10, preferably 0.2 to 2, MPa. In practice, the isomerization effluent which may have had lower boiling components removed, will be contacted with the retentate side of the membranes without additional compression to minimize capital and operating costs. The temperature for the membrane separation will depend in part on the nature of the membrane and on the temperature of the fraction. Thus, for polymer-containing membranes, temperatures should be sufficiently low that the strength of the membrane is not unduly adversely affected. Often the temperature is in the range of about 25° C. to 150° C. Thus, the conditions of the membrane separation may provide for a liquid or gas or mixed phase on the retentate side of the membrane. The permeate may be a gas or liquid or in mixed phase. If the fluid on the retentate side of the membrane is in the liquid or mixed phase, the permeate may be liquid, gaseous or mixed phase.

Preferably least a portion of the permeate fraction is recycled to the isomerization step. If lower boiling components (hydrogen, lower hydrocarbons, and, if used as a catalyst component, halogen compound) have not been removed prior to the isomerization effluent being passed to the membrane separator, these components are preferably removed from the permeate fraction prior to being introduced into the isomerization reactor. Any suitable separation process may be used including membrane separation and distillation or liquefaction.

The isomerization effluent will often contain C₅ and possibly higher boiling components as a coproduct of the isomerization and possibly as impurities in the feed. To prevent a build-up of such components in the recycle, at least a portion of the normal butane-containing permeate fraction is preferably subjected to distillation to remove the higher boiling components. The distillation may be continuous or may be of a periodically withdrawn portion of the permeate. As the distillation is a separation of C₄ components from C₅ and higher components, the distillation is more easily effected with substantially less heat duty than would be required for a deisobutanizer. This distillation may be effected in a distillation assembly which comprises a packed or trayed column and typically operates with a top pressure of between about 50 and 500 kPa (gauge) and a bottoms temperature of between about 75° and 170° C. The reflux to feed ratio of this column can be relatively low, say, between about 0.2:1 or 0.3:1 and 0.8:1.

Alternatively, at least a portion of the normal butane-containing permeate may be returned to the distillation assembly from which the normal butane-containing feedstock is obtained.

In another alternative, a distillation column adapted to remove lower boiling components from the isomerization effluent can be further adapted to provide a C₄-containing fraction as a side draw and a bottoms stream containing C₅ and higher boiling components.

Naphtha Isomerization, Replacement of Deisohexanizer

Processes for the isomerization of paraffins into more highly branched paraffins are widely practiced. Particularly important commercial isomerization processes are used to increase the branching, and thus the octane value of refinery streams containing paraffins of 4 to 8, especially 5 and 6, carbon atoms. The isomerate is typically blended with a refinery reformer effluent or alkylate to provide a blended gasoline mixture having a desired research octane number (RON).

The isomerization process proceeds toward a thermodynamic equilibrium. Hence, the isomerate will still contain normal paraffins that have low octane ratings and thus detract from the octane rating of the isomerate. Provided that adequate high octane blending streams such as alkylate and reformer effluent is available and that gasolines of lower octane ratings, such as 85 and 87 RON, are in demand, the presence of these normal paraffins in the isomerate has been tolerated.

Where circumstances demand higher RON isomerates, the isomerization processes have been modified by separating the normal paraffins from the isomerate and recycling them to the isomerization reactor. Thus, not only are normal paraffins that detract from the octane rating removed from the isomerate but also their return to the isomerization reactor increases the portion of the feed converted to the more highly desired branched paraffins.

In one embodiment of using sieving membranes in naphtha isomerization, the membranes enable commercially viable alternatives to a deisohexanizer or selective sorption to recover branched from normal isomers. Preferably least a portion, preferably at least about 90 mass-percent to essentially all, of the isomerization effluent is contacted with a retentate-side of a sieving membrane having a C₆ Permeate Flow Index of at least about 0.01, preferably at least about 0.02, and a C₆ Permeate Flow Ratio of at least about 1.25:1, preferably at least about 1.3:1, and often 1.35:1 to 5:1 or 6:1, under conditions including sufficient membrane surface area and pressure differential across the membrane to provide a retentate fraction of the isomerization effluent that has a reduced concentration of normal pentane and normal hexane, and to provide across the membrane at a permeate-side, a permeate fraction of the isomerization effluent having an increased concentration of normal pentane and normal hexane, said permeate fraction containing at least about 75, preferably at least about 80, and more preferably at least about 90, mass-percent of the normal pentane and normal hexane in the isomerization effluent contacted with the sieving membrane. Advantageously, at least a portion, preferably at least about 90 mass-percent to essentially all, of the permeate fraction is recycled for isomerization. Preferably at least about 50 mass percent of the isopentane contained in the isomerization effluent contacted with the membrane is in the retentate fraction. The permeate fraction may contain a significant concentration of non-linear paraffins. In many instances, the concentration of normal paraffin to the total permeate will be less than about 90 mass-percent, e.g., from about 25 to 90, say, 40 to 80, mass-percent.

In some embodiments, the mass ratio of (i) the rate of recycle of permeate fraction to the isomerization reactor to (ii) the rate of supply of hydrocarbon feedstock to the isomerization reactor is less than about 0.4:1, preferably between about 0.1 to 0.35:1. In comparison, for many commercial deisohexanizer-containing cyclic isomerization processes, this ratio falls between about 0.4:1 to 0.6:1. Accordingly, the processes of this invention using a sieve membrane, even with a relatively poor separation capability, have less impact on the size of an isomerization reactor than would a process using a deisohexanizer. Hence for retrofitting a once through reactor, using sieving membranes of this invention will thus more likely be able to use the existing isomerization reactor than would a retrofit employing a deisohexanizer.

Especially in retrofit situations, using a recycle stream obtained as the permeate of a sieving membrane can result in an increased flow rate through the isomerization reactor due to the presence of branched paraffins and other compounds that may also permeate the membrane. However, the increased flow rate can often be tolerated by isomerization reactors. For instance, comparing a separation of 95 mass-percent of the normal paraffins from an isomerization effluent to provide a recycle stream with 90 mass-percent normal paraffins with a separation of 95 mass-percent of the normal paraffins from an isomerization effluent to provide a recycle stream with only 50 mass-percent normal paraffins, the increase in required isomerization catalyst, all other things being equal, is only about 10 volume percent.

The principal components of the preferred feedstock for naphtha isomerization are cyclic and acyclic paraffins having from 4 to 7 carbon atoms per molecule (C₄ to C₇), especially C₅ to C₆, and smaller amounts of aromatic and olefinic hydrocarbons also may be present. Usually, the concentration of C₇ and heavier components is less than about 20 mass-percent of the feedstock. Although there are no specific limits to the total content in the feedstock of cyclic hydrocarbons, the feedstock generally contains between about 2 and 40 mass-percent of cyclics comprising naphthenes and aromatics. The aromatics contained in the naphtha feedstock, although generally amounting to less than the alkanes and cycloalkanes, may comprise from 2 to 20 mass-percent and more usually 5 to 10 mass-percent of the total. Benzene usually comprises the principal aromatics constituent of the preferred feedstock, optionally along with smaller amounts of toluene and higher-boiling aromatics within the boiling ranges described above.

In general, the naphtha feedstocks comprise at least about 15, often from about 40, preferably at least about 50, mass-percent to essentially all, linear paraffins. The mass ratio of non-linear paraffins to linear paraffins in the feedstocks is often less than 1:1, say, about 0.1:1 to 0.95:1. Non-linear paraffins include branched acyclic paraffins and substituted or unsubstituted cycloparaffins. Other components such as aromatics and olefinic compounds may also be present in the feedstocks. Preferably undesirable components such as sulfur moieties are removed from the feedstock.

The feedstock together with a recycle recovered from the isomerization reaction effluent is passed to one or more isomerization zones. The feedstock and recycle are usually admixed prior to entry into the isomerization zone, but if desired, may be separately introduced. In either case, the total feed to the isomerization zone is referred to herein as the isomerization feed. The recycle may be provided in one or more streams. The relative amount of recycle to feedstock can fall within a wide range. Often, the isomerization feedstock has a linear paraffins concentration of at least about 30, say, between about 35 and 90, preferably about 40 to 70, mass-percent, and a mole ratio of non-linear paraffins to linear paraffins of between about 0.2:1 to 1.5:1, and sometimes between about 0.4:1 to 1.2:1.

In the isomerization zone the isomerization feed is subjected to isomerization conditions including the presence of isomerization catalyst preferably in the presence of a limited but positive amount of hydrogen as described in U.S. Pat. Nos. 4,804,803 and 5,326,296, both herein incorporated by reference. The isomerization of paraffins is generally considered a reversible first order reaction. Thus, the isomerization reaction effluent will contain a greater concentration of non-linear paraffins and a lesser concentration of linear paraffins than does the isomerization feed. In preferred embodiments of this invention, the isomerization conditions are sufficient to isomerize at least about 20, preferably, between 30 and 60, mass-percent of the normal paraffins in the isomerization feed. In general, the isomerization conditions achieve at least about 70, preferably at least about 75, say, 75 to 97, percent of equilibrium for C₆ paraffins present in the isomerization feed. In many instances, the isomerization reaction effluent has a mass ratio of non-linear paraffins to linear paraffins of at least about 2:1, preferably between about 2.5 to 4:1.

The isomerization catalyst is not critical to the broad aspects of the processes of this invention, and any suitable isomerization catalyst may find application. Isomerization conditions in the isomerization zone include reactor temperatures usually ranging from about 40° to 250° C. Lower reaction temperatures are generally preferred in order to favor equilibrium mixtures having the highest concentration of high-octane highly branched alkanes and to minimize cracking of the feed to lighter hydrocarbons. Temperatures in the range of from about 100° to about 200° C. are preferred in the present invention. Reactor operating pressures generally range from about 100 kPa to 10 MPa absolute, preferably between about 0.5 and 4 MPa absolute. Liquid hourly space velocities range from about 0.2 to about 25 volumes of isomerizable hydrocarbon feed per hour per volume of catalyst, with a range of about 0.5 to 15 hr⁻¹ being preferred.

Hydrogen is admixed with or remains with the isomerization feed to the isomerization zone to provide a mole ratio of hydrogen to hydrocarbon feed of from about 0.01 to 20, preferably from about 0.05 to 5. The hydrogen may be supplied totally from outside the process or supplemented by hydrogen recycled to the feed after separation from isomerization reactor effluent. Light hydrocarbons and small amounts of inerts such as nitrogen and argon may be present in the hydrogen. Water should be removed from hydrogen supplied from outside the process, preferably by an adsorption system as is known in the art. In a preferred embodiment the hydrogen to hydrocarbon mol ratio in the reactor effluent is equal to or less than 0.05, generally obviating the need to recycle hydrogen from the reactor effluent to the feed. Especially where a chlorided catalyst is used for isomerization, the isomerization reaction effluent is contacted with a sorbent to remove any chloride components such as disclosed in U.S. Pat. No. 5,705,730.

A pressure drop is maintained across the sieving membrane in order to effect the desired separation at suitable permeation rates. Often, the pressure drop is in the range of about 0.1 to 10, preferably 0.2 to 2, MPa. In practice, the isomerization effluent will be contacted with the retentate side of the membranes without additional compression to minimize capital and operating costs. The temperature for the membrane separation will depend in part on the nature of the membrane and on the temperature of the isomerization effluent. Thus, for polymer-containing membranes, temperatures should be sufficiently low that the strength of the membrane is not unduly adversely affected. In most instances, the temperature for the separation is the temperature of the isomerization effluent. Often the temperature is in the range of about 25° C. to 150° C. Thus, the conditions of the membrane separation may provide for a liquid or gas or mixed phase on the retentate side of the membrane. Regardless of the phase of the fluid on the retentate side, the permeate may be a gas. If the fluid on the retentate side of the membrane is in the liquid phase, the permeate may be liquid, gaseous or mixed phase.

Sufficient membrane surface area is provided that under steady state conditions at least about 75, preferably at least about 80, and more preferably at least about 90, mass-percent of the total linear paraffins in the isomerization effluent are contained in the permeate. The concentration of the linear paraffins in the permeate will depend upon the selectivity of the sieving membrane. While the membrane may be highly selective and provide a permeate containing 99 mass-percent or more of linear paraffins, advantageous embodiments of this invention can be achieved with lesser purity permeates. The concentration of normal paraffin to the total permeate in these embodiments will be less than about 90 mass-percent, e.g., from about 25 to 90, say, 40 to 80, mass-percent. The remainder of the effluent will typically be branched and cyclic compounds contained in the isomerization effluent as well as any residual light ends such as hydrogen and methane.

Some high flux, sieving membranes permit a portion of branched paraffins to permeate. The relative rates of permeation will depend upon the molecular configuration of the paraffins. C₆-cyclic paraffins and substituted C₆-cyclic paraffins will typically be more readily rejected by the sieving membrane than C₆-branched paraffins, and monomethyl-branch paraffins will pass more readily through the membrane than dimethyl-branched or ethyl-branched paraffins. As the methylpentanes typically have a lower RON than the more highly branched 2,2-dimethylbutane and 2,3-dimethylbutane, the processes of the invention can further enhance the octane rating of the isomerization effluent. In some instances, between about 20 and 70 mass-percent of the monomethyl-branched paraffins contained in the isomerization effluent are passed into the permeate. The octane rating of the retentate may, due to retention dimethylbutanes and cyclics, in some instances have an octane rating of at least about 90, preferably at least about 91, RON. Preferably, at least a portion of the permeate is recycled to the isomerization step.

Naphtha Isomerization, Improving Deisohexanizer

Another use of the sieving membranes of this invention in isomerization processes involves enhancing the octane rating of the product stream from a deisohexanizer column. To be economically viable, the addition of the membrane separation unit operation to a distillation should involve little capital cost and minimize the need for intervening unit operations. Bouney, et al., in WO 2005/049766, disclose such an assembly using a side cut from the deisohexanizer as a sweep fluid on the permeate side of the membrane. The presented example requires not only a large membrane surface area, but also an elevated temperature of 300° C.

The sieving membranes of this invention not only are more attractive due to the higher flux possible, but also need not require such high temperatures to achieve the separation. Moreover, since the membranes are used in a concentration mode, high octane product can still be obtained even with a low selectivity. The larger molecules that co-permeate with the n-pentane can be returned to the isomerization. The increase in fluid flow through the isomerization reactor, even at half the selectivity of the membrane proposed in Example 1 of WO 2005/049766, is nominal.

The broad aspects of the processes comprise:

a. isomerizing a feedstock containing normal pentane and normal hexane wherein at least about 15 mass-percent of the feedstock is normal pentane and normal hexane under isomerization conditions including the presence of isomerization catalyst to provide an isomerization effluent containing normal pentane and normal hexane but in a concentration less than that in the feedstock and also containing dimethylbutanes and methylpentanes,

b. distilling at least a portion, preferably at least about 90 mass-percent and most preferably essentially all, of the isomerization effluent to provide at least one lower boiling, pentane-containing fraction comprising isopentane and normal pentane, and a higher boiling fraction containing normal hexane,

c. contacting at least a portion, preferably at least about 90 mass-percent and most preferably essentially all, of at least one pentane-containing fraction from step b with a retentate-side of a sieving membrane having a C₆ Permeate Flow Index of at least about 0.01, more preferably at least about 0.02, and a C₆ Permeate Flow Ratio of at least about 1.25:1, more preferably at least about 1.3:1, and often 1.35:1 to 5:1 or 6:1, under conditions including sufficient membrane surface area and pressure differential across the membrane to provide a retentate fraction that has a reduced concentration of normal pentane, and to provide across the membrane at a permeate-side, a permeate fraction of the lower boiling fraction having an increased concentration of normal pentane, said permeate fraction containing at least about 50, preferably at least about 75, and most preferably at least about 90, mass-percent of the normal pentane contained in the isopentane-containing fraction contacted with the membrane.

Not only can the octane rating of the product be increased, but also the distillation of step b can be operated such that more of the less desirable methylpentanes are contained in the lower boiling fraction containing the dimethylbutane than would typically be the case with conventional operation of a deisohexanizer column in a commercial isomerization. The separation of methylpentanes from dimethylbutanes is difficult due to the proximity of boiling points and thus not only does a deisohexanizer us an extensive number of distillation trays, often in the range of 80 trays, but also a large reflux to feed ratio, e.g., 2:1 to 3:1. Hence, the operation of the deisohexanizer requires substantial reboiler heat. Sieving membrane can be used to remove sufficient methylpentanes from the dimethylbutane-containing fraction to provide a desirable octane rating product. Accordingly, for an existing deisohexanizer, the reflux ratio can be reduced resulting in energy savings without undue loss in the octane rating of the product. In one preferred aspect, the net reflux to feed weight ratio of the distillation of step b is less than 2:1. In a further embodiment, a separate isopentane-containing fraction and a dimethylbutane-containing fraction are provided by the distillation and each fraction is subjected to membrane separation such that normal pentane and methylpentanes are removed from the isomerization product.

Most often, the deisohexanizer is adapted to provide the normal hexane-containing stream as a side stream and provides a bottoms stream comprising normal heptane. The deisohexanizer may be a packed or trayed column and typically operates with a top pressure of between about 50 and 500 kPa (gauge) and a bottoms temperature of between about 75° and 170° C.

The composition of the lower boiling fraction from the deisohexanizer will depend upon the operation and design of the assembly and any separation processes to which the isomerization effluent has been subjected. For instance, if the stream to the deisohexanizer contains lights such as C₁ to C₄ compounds, the deisohexanizer may be adapted to provide an overhead fraction containing these lights, and a side-draw fraction containing C₅ compounds and branched C₆ compounds, especially dimethylbutanes. Typically the lower boiling fraction contains 20 to 60 mass-percent dimethylbutanes; 10 to 40 mass-percent normal pentane and 20 to 60 mass-percent isopentane and butane. Depending upon the operation of the deisohexanizer, the lower boiling fraction may also contain significant, e.g., at least about 10 mass-percent methylpentanes. The deisohexanizer may also be adapted to provide a C₅-rich stream in addition to the lower boiling stream.

The higher boiling normal hexane-containing fraction also contains methylpentanes and methylcyclopentane. As stated earlier, the processes of this invention permit the deisohexanizer to be operated more economically resulting in a greater concentration of dimethylbutanes in the normal hexane-containing fraction. Often the normal hexane-containing fraction will contain about 2 to 10 mass-percent dimethylbutanes; about 5 to 50 mass-percent normal hexane; about 20 to 60 mass-percent methylpentanes, and about 5 to 25 mass-percent methylcyclopentane. Typically, the deisohexanizer will be designed to provide a side stream that contains methylpentanes, methylcyclopentane, normal hexane, dimethylbutanes and cyclohexane, and a bottoms stream that contains cyclohexane and C₇+ hydrocarbons. If the normal hexane-containing fraction were the bottom fraction of the deisohexanizer, that fraction would also contain such heavier hydrocarbons.

If desired, two lower boiling fractions may be generated by the distillation, one richer in isopentane and normal pentane than the other, and the other richer in dimethylbutane. Either or both of these fractions can be subjected to membrane separations. At least a portion, preferably at least about 50, and more preferably at least about 80, mass-percent to substantially all of the deisohexanizer a lower boiling fraction is contacted with the retentate side of a selective membrane to provide a retentate fraction of the isomerization reaction effluent that has a higher octane rating.

A pressure drop is maintained across the membrane in order to effect the desired separation at suitable permeation rates. The pressure drop is often in the range of about 0.1 to 10, preferably 0.2 to 2, MPa. In practice, the deisohexanizer overhead will be contacted with the retentate side of the membranes without additional compression to minimize capital and operating costs. The temperature for the membrane separation will depend in part on the nature of the membrane and on the temperature of the deisohexanizer overhead. Thus, for polymer-containing membranes, temperatures should be sufficiently low that the strength of the membrane is not unduly adversely affected. In most instances, the temperature for the separation is the temperature of the deisohexanizer overhead. Often the temperature is in the range of about 25° C. to 150° C. Thus, the conditions of the membrane separation may provide for a liquid or gas or mixed phase on the retentate side of the membrane. Regardless of the phase of the fluid on the retentate side, the permeate may be a gas. If the fluid on the retentate side of the membrane is in the liquid phase, the permeate may be liquid, gaseous or mixed phase.

Sufficient membrane surface area is provided such that under steady state conditions at least about 75, preferably at least about 80, and more preferably at least about 90, mass-percent of the total linear paraffins in the overhead are contained in the permeate. The concentration of the linear paraffins in the permeate will depend upon the selectivity of the membrane. While the membrane may be highly selective and provide a permeate containing 99 mass-percent or more of linear paraffins, advantageous embodiments of this invention can be achieved with lesser purity permeates. The concentration of normal paraffin to the total permeate in these embodiments will be less than about 90 mass-percent, e.g., from about 25 to 90, say, 40 to 80, mass-percent. The remainder of the effluent will typically be branched compounds contained in the deisohexanizer overhead. Preferably least a portion of the permeate is recycled to the isomerization step.

Reactor Feed Optimization and Adjustment

The membranes of this invention may be used for treating a feed to a reactor to enhance the desired reaction. For instance, the membranes may be used to remove one or more components that may adversely affect the reactor or catalyst therein or may reduce reaction efficiency or produce undesirable by-products.

With respect to the former, the components that may adversely affect the reactor or catalyst therein include catalyst poisons as well as components that can result in, for instance, coking. Especially with high flux membranes of this invention, it may be economically feasible to treat an entire feed stream, and adequate removal of the adverse components may be achieved even with a relatively low selectivity membrane. For instance, at least a portion of naphthalenes, which are considered to be coke precursors, could be removed from alkylaromatic-containing streams which are to undergo chemical reaction such as transalkylation.

Isomerization Reactor Feed Optimization

With respect to equilibrium limited reactions, removal of at least a portion of the desired product from the feed to the equilibrium reaction can enhance the efficiency of the reaction. For example, if a naphtha range feedstock is to be isomerized, by recovering at least a portion of these cyclic and branched components, not only is the volume of feedstock to the isomerization reduced per given output of gasoline grade product but also the conversion of feed to the isomerization to the sought isomerization products such as isopentane and dimethylbutane is enhanced. Additionally, the net octane contribution of the C₅ component of the feedstock is enhanced with the processes of this invention. The equilibrium for the isomerization provides an effluent containing about 60 mass parts of isopentane which has a high octane rating per 40 mass parts of normal pentane which has a low octane rating. By separating isopentane from the feedstock prior to isomerizing, the net isopentane from the isomerization and from the separation will be grater than the 60:40 ratio, and is preferably greater than 65:35, and may, especially with light C₆ feedstocks, be at least about 75:25.

The broad aspects of the processes comprise:
a. contacting at least a portion, preferably at least about 50 mass-percent and most preferably essentially all, of a feedstock comprising paraffins having 5 and 6 carbon atoms wherein at least about 15 mass-percent of the feedstock is linear paraffin and at least about 15 mass percent of the feedstock is cyclic and branched paraffin having 5 and 6 carbon atoms with a retentate-side of a sieving membrane having a C₆ Permeate Flow Index of at least about 0.01, more preferably at least about 0.02, and a C₆ Permeate Flow Ratio of at least about 1.25:1, more preferably at least about 1.3:1, and often 1.35:1 to 5:1 or 6:1, under conditions including sufficient membrane surface area and pressure differential across the membrane to provide a retentate fraction that has an increased concentration of cyclic and branched paraffins having 5 and 6 carbon atoms, and to provide across the membrane at a permeate-side, a permeate fraction having an increased concentration of normal pentane and normal hexane, said permeate fraction containing at least about 75, preferably at least about 90, mass-percent of the normal hexane contained in the portion of the feedstock contacted with the membrane,
b. isomerizing at least a portion, preferably at least about 90 mass-percent and most preferably essentially all, of the permeate fraction and, optionally additional feedstock, under isomerization conditions including the presence of isomerization catalyst to provide an isomerization effluent containing a reduced concentration of linear paraffins, and
c. distilling at least a portion, preferably at least about 90 mass-percent and most preferably essentially all, of the isomerization effluent to provide a lower boiling fraction containing dimethylbutanes (2,2-dimethylbutane and 2,3-dimethylbutane) and a higher boiling, normal hexane-containing fraction containing normal hexane.

Advantageously, at least a portion of both of the retentate fraction of step a and the lower boiling fraction of step c are used to formulate gasoline.

Preferably at least about 30 mass percent of the isopentane, and more preferably the cyclic and branched paraffins, in the feedstock contacted with the membrane is retained in the retentate. In one embodiment, the retentate fraction of step a and the lower boiling fraction of step c are admixed. The admixing may occur by combining the retentate fraction with the lower boiling fraction after removal from the distillation of step c or may occur by introducing retentate fraction into step c. In many instances, the feedstock contains methylpentanes as well as isopentane. In such cases, it is often preferred to feed the retentate fraction from step a, which will contain methylpentanes, to the distillation of step c such that at least a portion of the methylpentanes, which have lower octane values, are distilled from the dimethylbutanes.

Isomerization Reactor Feed Optimization, Other Examples

Another example of the use of a sieving membrane of this invention for feed optimization is to treat a feedstock containing normal and branched and cyclic hydrocarbons to provide a stream enriched in normal hydrocarbons for steam cracking and a stream depleted in normal hydrocarbons for reforming. Not only are normal hydrocarbons preferred for steam cracking, but also the concentration of branched and cyclic hydrocarbons which have a greater tendency to coke under steam reforming conditions, is reduced. The stream richer in branched and cyclic hydrocarbons is a more desirable feedstock for reforming.

In a further example, dialkylbenzenes and dibenzylalkanes could be removed from alkylbenzenes prior to sulfonation to make surfactants to assure product quality of the sulfonate.

Yet another example pertains to para-xylene processes where ethylbenzene is a common impurity. When xylenes are isomerized, ethylbenzene can also react with a xylene to form toluene and methylethylbenzene. The sieving membranes of this invention could be used to treat at least a portion of the feed to the xylene isomerization reactor to selectively permeate ethylbenzene as compared to ortho- and meta-xylene. Not only is the co-production of C₉+ aromatics reduced, but also the load on the isomerization reactor as well as distillation columns in the para-xylene production loop. Ethylbenzene can comprise, in some instances, between about 12 and 20 mass percent of the stream in the loop. The membrane separation can advantageously reduce the ethylbenzene concentration to less than about 10, and most preferably to less than about 7, mass percent of the stream.

Distillation Assist

Separation using the membranes of this invention can benefit a wide variety of distillation unit operations. For instance, the high flux sieving membranes, even with low selectivity, may be used to break azeotropes. Another use is to remove at least a portion of the lights or heavies in the stream to be fractionated to debottleneck the distillation column and/or reduce the size or reboiler load on the column. Since even Low Selectivity Membranes can effectively be used in the concentrating mode, relatively pure retentate can be recovered.

Many chemical and petroleum refining streams contain lights in addition to the desired product, especially where the streams are effluents from reactors. Lights are typically hydrogen and may include hydrocarbons of up to 4 carbon atoms. The lights can render subsequent distillations and other unit operations more difficult to effect and control. Traditionally these streams are subjected to a stabilization, i.e., a fractionation to remove lights. The sieving membranes may be used to remove lights.

By way of example, naphtha reforming and cracking (e.g., fluidized catalytic cracking or thermal cracking) in a refinery yields a range of hydrocarbon products as well as hydrogen. Distillation is used to separate these fractions into useful streams. Normally, the distillations are sequential with respect to boiling point. A debutanizer is generally used to remove C₄ and lighter components and provide one or more fractions of higher molecular weight. The feed to the debutanizer can be subjected to membrane separation with a sieving membrane, especially a high flux, low separation sieving membrane to provide on the retentate side a relative pure stream of C₇ and higher hydrocarbons. Advantageously, this retentate stream contains at least about 30, and sometimes at least about 50, mass percent of the C₇ and higher hydrocarbons in the feed. The retentate can immediately go to storage or the product pool. While some of the C₇ and higher hydrocarbons will pass to the distillation train, the reboiler load can be reduced. For existing facilities, advantages can also be taken in terms of reducing bottlenecks, and for new facilities, the size of the columns in the distillation train can be reduced.

Similarly, high octane streams can be removed from feeds to reformers, thus not only reducing the reactor size, but also subsequent separation unit operations. Feeds to reformers often contain aromatics and other high octane components, but in low concentration, frequently less than about 20 or 30 mass percent. Thus, the sieving membranes, including Low Selectivity Membranes, can be used to provide a fraction containing at least about 70 mass percent of these components. The fraction can be sent to, e.g., the octane pool of a refinery. The capacity of the reformers can thus be debottlenecked with potential savings in energy. If the feedstock contains cyclic aliphatics, it may be desired to dehydrogenate the stream to convert the cyclic aliphatics to aromatics and then effect the separation using the sieving membranes of this invention.

Sieving membranes may also find application in the concentrating mode to remove a portion of the propane from a propane/propylene stream to a C₃ splitter column. The ratio of propylene in a propane/propylene stream will vary depending upon its source. For example, a propane dehydrogenation process typically provides a stream containing about 35 mass percent propylene whereas from an FCC unit the stream generally contains about 75 mass percent propylene. For many applications, propylene specifications require a purity of at least 99.5 mass percent. The sieving membranes of this invention, even if low separation, can reduce the amount of propane in the feed to the splitter and thus reduce the reboiler load and size of the splitter. Advantageously, the sieving membranes are used in a concentration mode with propane being the Retentant. Even if a substantial portion of the propane co-permeates with propylene, the enrichment of the feed to the splitter enables the splitter to be decreased in size. For example, if the feed to a splitter is about 35 mole percent propylene, increasing the concentration to about 67 mole percent enable reducing column diameter by about 14 percent, trays by 7 percent, reboiler and condenser duty by over 20 percent, yet still achieve the same propylene product purity. Similarly, using sieving membranes to increase the feed purity from 90 to 95 mole percent, i.e., about half the propylene permeates the membrane, can lead to about the same reduction in column size and reboiler and condenser duty.

Another way of assisting a distillation is to remove dissolved components in the feed that would otherwise have to be addressed in the distillation or overhead stream. For example, some hydrogen remains dissolved in many petroleum and chemical reaction effluents even after a flash separation, e.g., in a para-xylene isomerization or transalkylation process or a reforming or cracking process. The sieving membranes of this invention can be used to remove hydrogen. In one embodiment, the feed containing hydrogen (either with or without being subjected to a flash separation) and a range of hydrocarbons can be contacted with a sieving membrane of this invention. Lower hydrocarbons, say, methane and possibly ethane, would be separated from higher hydrocarbons such as butane or light naphtha streams or aromatics. At least about 80, and preferably at least about 90, if not substantially all of the hydrogen permeates the membrane. While the permeate may contain some lower hydrocarbon, and especially with Low Selectivity Membranes, some of the higher hydrocarbons, the distillation may be effected with attenuated, if not eliminated, adverse effect from hydrogen. In some instances it may be desired to recover any such higher hydrocarbon from the permeate by any convenient unit operation such as a knock out pot. The higher hydrocarbon can be passed to the distillation column. Since the recovered hydrocarbon will be a relatively small stream in comparison to the feed, any dissolved hydrogen remaining in the higher hydrocarbon stream will often be tolerated in the distillation process.

Another type of distillation assist that can be provided by the sieving membranes of this invention is to remove one or more components from a stream withdrawn from the distillation column and recycling one of the retentate or permeate to distillation column. For example, a xylene column in a para-xylene process serves to separate C₈ aromatics from C₉ and higher aromatics. The specifications of the C₈ fraction require that C₉ and higher aromatics be present in amounts of less than about 500 ppm-m. The size and reboiler load of the xylene column can be reduced by withdrawing a side stream containing C₈ aromatics and subjecting the stream to separation by a sieving membrane of this invention, including low separation sieving membranes, to provide a retentate containing C₈ aromatics that is enriched in C₉ and higher aromatics and a permeate that has a lower concentration of C₉ and higher aromatics than the side stream. The permeate is returned to the distillation column and the retentate can be subjected to further distillation, e.g., in a heavies column. Preferably, the side stream is less than about 50, more preferably less than about 20, mass percent of the feed to the xylene column and the retentate contains less than about 10 mass percent of the xylenes in the feed to the xylene column.

Overhead streams from chemical and refinery distillations often contain hydrogen and lower hydrocarbons and may provide a mixed phase stream upon condensation. The partial pressure of the heavier hydrocarbons will result in the gas phase containing some heavier hydrocarbons. Withdrawing the gas phase will also result in some of the heavier hydrocarbons. The sieving membranes of this invention, including Low Selectivity Membranes, may find utility in removing the heavier components that that would otherwise be lost with the removal of the gas phase.

Reaction Assist

The sieving membranes of this invention may be used to separate products from reactions, especially where under conditions of the reaction, the desired product is still reactive. For instance, in alkylation reactions or dimerization or oligomerization reactions where a specific species is sought, the sieving membranes, including Low Selectivity Membranes, can be used to remove at least a portion of the sought species from the reaction fluid to reduce the co-production of higher molecular weight species. Usually, to prevent the undue formation of higher molecular weight species, one of the reactants is provided in substantial stoichiometric excess such that the probability of reaction is greater with the reactant than with the product. However, considerable capital and energy costs can exist in recovering the excess reactant. One such reaction is the alkylation of benzene with olefin, e.g., of 1 to 20 or more carbons, to provide alkylbenzenes. The reaction fluid can be continually passed through a sieving membrane to remove at least a portion of the sought alkylbenzenes. The lower concentration of alkylbenzene may, if desired, enable the ratio of benzene to olefin to be reduced.

The sieving membranes of this invention can be used to remove co-products and undesired by-products from reactors and reactor effluents. For instance, the dehydrocyclodimerization of liquified petroleum gas (LPG) produces petrochemical aromatics. In the process, the reaction effluent is split into liquid and vapor fractions. The liquid fraction, which contains aromatics is further processed to recover the aromatics and unreacted LPG. The vapor stream contains hydrogen, methane, ethane and some of the unreacted LPG. This vapor is compressed and sent to a gas recovery section, usually a cryogenic unit, to provide hydrogen, light paraffins and LPG. A sieving membrane can be used to concentrate a LPG fraction for recycle to the reactor. The permeate, which contains substantially all of the hydrogen and methane and a portion of ethane and higher hydrocarbons, is of substantially less volume. Thus the size and energy requirements for the cryogenic separation can be reduced.

In another use, sieving membranes of this invention can be used to separate paraffins from a petroleum cracking (thermal or catalytic) reactor for recycle to the reactor to make higher octane gasoline product.

Another type of reaction assist application for the membranes of this invention is the recovery of one or more non-product components in the reaction effluent such as catalysts, diluents, and co-reactants. For instance, homogeneous catalyst such as using in solution reactions for hydroformylation, oligomerization, and the like can be recovered by the sieving membranes of this invention. Especially in highly exothermic reactions or reactions where the desired product can further react such as the alkylation of benzene, large amounts of inert diluent or stoichiometric excess of one of the reactants, is used for control or selectivity. For purposes of economy, the diluent or reactant is recycled to the reactor. The sieving membranes of this invention may be used to remove a least a portion of these components from the reaction effluent.

Another example of a reaction assist use of the sieving membranes of this invention is in processes for the isomerization of non-equilibrium mixtures of xylenes and ethylbenzene. In these processes, which may be conducted in one or more reaction stages, the xylenes are isomerized and ethylbenzene is converted to xylenes. Typically these processes require the presence of naphthenes. In the processes of this invention in which ethylbenzene is isomerized, typically the feed also contains naphthenes in an amount sufficient to enhance the ethylbenzene conversion. Naphthenes are cyclic paraffins and may include, for purposes herein, cyclic compounds having non-aromatic unsaturation in the ring structure. A convenient source of naphthenes is the isomerization process itself which produces naphthenes. Typically the naphthenes that are recycled are monocyclic compounds, especially 5 and 6 carbon atom rings, having from 5 to 9 carbon atoms. The downstream unit operations will define the composition and amount of naphthenes being recycled. Generally, the naphthenes are present in an amount of about 2 to 20, preferably from about 4 to 15, mass-percent of the feed. Equilibria may exist under isomerization conditions between naphthenes and aromatics. Thus, at isomerization conditions that convert a greater percentage of ethylbenzene, greater concentrations of naphthenes are preferred.

A practical limit exists as to the concentration of naphthenes in the feed to an isomerization reactor in a xylene production facility. Not only will the naphthenes need to be handled by the other unit operations in the xylene production facility, but also some naphthenes are co-boilers with other components such as toluene that are desirably recovered from the xylene production loop. Hence compromises must be made between enhancing ethylbenzene conversion and the difficulties in handling large amounts of naphthenes in other unit operations.

The sieving membranes can be used to enable advantageous concentrations of naphthenes in the ethylbenzene conversion reactor but recover the naphthenes from the isomerization reactor effluent. While the naphthenes could be recovered from the reactor effluent directly, a particularly attractive process involves recovery of naphthenes from a toluene-containing fraction from a toluene splitter that provides a lower boiling toluene-containing fraction and a bottoms containing xylenes that are passed to a xylene column and xylene isomer recovery. Often the concentration of naphthenes can be in the range of about 5 to 30 mass percent based upon the total C₈ aromatics in the feed to the ethylbenzene conversion reactor.

What is claimed is:

1. A sieving membrane comprising a microporous barrier in a meso/macroporous structure, said membrane characterized in having a C₆ Permeate Flow Index of at least about 0.01 and a C₆ Permeate Flow Ratio of at least about 1.1:1.

2. The sieving membrane of claim 1 which is a composite membrane having a porous support having a C₆ Permeate Flow Index of at least about 10.

3. The sieving membrane of claim 2 in which molecular sieve resides within pores of the porous support.

4. The sieving membrane of claim 1 in which the microporous barrier has a thickness less than 100 nanometers.

5. The sieving membrane of claim 1 in which the membrane contains defects and the C₆ Permeate Flow Ratio is between about 1.35:1 to 8:1.

6. A commercial-scale separator containing sieving membrane of claim 1.

7. A sieving membrane comprising a discontinuous assembly of microporous barrier, said barrier having a major dimension less than about 100 nanometers associated with a meso/macroporous structure defining fluid flow pores, wherein barrier is positioned to hinder fluid flow through the pores of the meso/macroporous structure.

8. The sieving membrane of claim 7 in which microporous barrier resides within pores of the meso/macroporous structure.

9. The sieving membrane of claim 8 in which the meso/macroporous structure is on a porous support.

10. The sieving membrane of claim 8 in which the discontinuous assembly of barrier defines voids and at least a portion of the voids are at least partially occluded by a solid material therein.

11. A sieving membrane of claim 7 in which the barrier is a particle.

12. A sieving membrane of claim 7 in which the barrier is formed in situ.

13. A sieving membrane of claim 7 in which the barrier comprises zeolite.

14. A sieving membrane of claim 7 in which barrier is agglomerated.

15. A sieving membrane of claim 7 in which the discontinuous assembly of barrier defines voids and at least a portion of the voids are at least partially occluded by a solid material therein.

16. The sieving membrane of claim 15 in which the solid material comprises at least one of polymer and inorganic particle.

17. The sieving membrane of claim 16 in which the solid material is bonded to barrier.

18. The sieving membrane of claim 16 in which the mass ratio of barrier to polymer is 1:2 to 100:1.

19. The sieving membrane of claim 7 which has an Intrinsic Permeation Thickness of less than about 70 nanometers.

20. A process for separating by selective permeation at least one component from at least one other component in a fluid mixture containing said components by contact of said fluid with a feed side of a sieving membrane having an opposing permeate side under permeation conditions to provide on said feed side a retentate containing a reduced concentration of said at least one component and a permeate containing an enriched concentration of said at least one component on said permeate side, characterized in that said sieving membrane comprises at least one of:
a. a microporous barrier in a meso/macroporous structure, said membrane characterized in having a C₆ Permeate Flow Index of at least about 0.01 and a C₆ Permeate Flow Ratio of at least about 1.1:1, and
b. a discontinuous assembly of microporous barrier, said barrier having a major dimension less than about 100 nanometers associated with a meso/macroporous structure defining fluid flow pores, wherein barrier is positioned to hinder fluid flow through the pores of the meso/macroporous structure.

21. The process of claim 20 wherein the fluid stream comprises effluent from an isomerization reaction.

22. The process of claim 21 wherein the isomerization reaction is a butane isomerization and the sieving membrane comprises a discontinuous assembly of microporous barrier, said barrier having a major dimension less than about 100 nanometers associated with a meso/macroporous structure defining fluid flow pores, wherein barrier is positioned to hinder fluid flow through the pores of the meso/macroporous structure.

23. The process of claim 21 wherein the isomerization reaction is a butane isomerization and the effluent comprises n-butane and i-butane and pentanes and higher boiling components, the sieving membrane has a C₄ Permeate Flow Index of at least about 0.01 and a C₄ Permeate Flow Ratio of at least about 1.25:1 under conditions including sufficient membrane surface area and pressure differential across the membrane to provide a retentate fraction containing at least about 80 mass-percent isobutane, and to provide across the membrane at a permeate-side, a permeate fraction having an increased concentration of normal butane, said permeate fraction preferably containing at least about 80 mass-percent of the normal butane contained in the normal butane-containing fraction contacted with the membrane; and at least a portion of the permeate is subjected to a distillation to provide a normal butane-containing fraction and a bottoms stream containing pentanes and higher components.

24. The process of claim 21 wherein the isomerization reaction is an isomerization of a feedstock comprising paraffins having 5 and 6 carbon atoms wherein at least about 15 mass-percent of the feedstock is normal pentane and normal hexane and the effluent comprises isomerized paraffins, the retentate fraction has a reduced concentration of normal pentane and normal hexane, and the permeate fraction of the isomerization effluent has an increased concentration of normal pentane and normal hexane, said permeate fraction containing at least about 75 mass-percent of the normal pentane and normal hexane in the isomerization effluent contacted with the sieving membrane.

25. The process of claim 24 wherein the isomerization effluent comprises methylpentane, and 20 to 70 mass-percent of the methylpentane contacting the feed side of the sieving membrane passes to the permeate side of the membrane.

26. The process of claim 21 wherein the isomerization reaction is an isomerization of a feedstock comprising paraffins having 5 and 6 carbon atoms wherein at least about 15 mass-percent of the feedstock is normal pentane and normal hexane to provide an isomerization effluent, at least a portion of the isomerization effluent is distilled to provide at least one lower boiling fraction containing isopentane and normal pentane and a higher boiling stream containing normal hexane, said retentate fraction has a reduced concentration of normal pentane, and said permeate fraction has an increased concentration of normal pentane, said permeate fraction containing at least about 50 mass-percent of the normal pentane contained in the fraction contacted with the sieving membrane.

27. The process of claim 21 wherein the isomerization effluent comprises methylpentanes and the permeate fraction has an increased concentration of methylpentanes, said permeate fraction containing at least about 20 mass-percent of the methylpentanes contained in the fraction contacted with the sieving membrane.

28. The process of claim 21 wherein the isomerization reaction is an isomerization of a non-equilibrium mixture of xylenes and the permeate fraction has an increased concentration of para-xylene.

29. The process of claim 20 wherein the fluid mixture contacted with the membrane is a feed stream to a reactor.

30. The process of claim 20 wherein the fluid mixture contacted with the membrane is a feed stream to a distillation column.
